(19) United States
(12) Patent Application Publication
(10) Pub. No.: US 2025/0192844 A1
(43) Pub. Date: Jun. 12, 2025

(54) TRANSMISSION RECEPTION POINT SELECTION FOR COHERENT JOINT TRANSMISSIONS

(71) Applicant: QUALCOMM INCORPORATED, San Diego, CA (US)

(72) Inventors: Jing Dai, Beijing (CN); Liangming Wu, Beijing (CN); Chenxi Hao, Beijing (CN); Min Huang, Beijing (CN); Chao Wei, Beijing (CN); Wei Xi, Beijing (CN); Hao Xu, Beijing (CN)

(21) Appl. No.: 18/843,657

(22) PCT Filed: Apr. 29, 2022
(86) PCT No.: PCT/CN2022/090234

§ 371 Date: Sep. 3, 2024

(51) Int. Cl. H04B 7/06; H04B 7/024; H04B 7/10

(52) U.S. Cl. CPC H04B 7/0626; H04B 7/024; H04B 7/06952; H04B 7/10

(57) ABSTRACT

Methods, systems, and devices for wireless communications are described. A user equipment (UE) may receive channel state information (CSI) reference signals (CSI-RSs) from multiple transmission reception points (TRPs) and may perform measurements on the CSI-RSs. The UE may then select a subset of the multiple TRPs with which to communicate, and the UE may transmit an indication of the selected TRPs in a CSI report. In some cases, the UE may indicate a common subset of TRPs with which the UE may communicate on multiple layers, or the UE may indicate a respective subset of TRPs with which the UE may communicate on each layer of multiple layers. The UE may also provide additional information in the CSI report for the selected TRPs. The selected TRPs may then use the additional information provided in the CSI report to identify suitable configurations for communicating with the UE.

### CROSS REFERENCE

The present application is a 371 national stage filing of International PCT Application No. PCT/CN2022/090234 by Dai et al. entitled “TRANSMISSION RECEPTION POINT SELECTION FOR COHERENT JOINT TRANSMISSIONS,” filed Apr. 29, 2022, which is assigned to the assignee hereof, and which is expressly incorporated by reference in its entirety herein.

### FIELD OF TECHNOLOGY

The following relates to wireless communications, including transmission reception point selection for coherent joint transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some wireless communications systems, a UE may communicate with multiple transmission reception points (TRPs) to improve the reliability of communications. Improved techniques for supporting multi-TRP communications may be desirable.

### SUMMARY

The described techniques relate to improved methods, systems, devices, and apparatuses that support transmission reception point (TRP) selection for coherent joint transmissions. A user equipment (UE) may receive channel state information (CSI) reference signals (CSI-RSs) from multiple TRPs and may perform measurements on the CSI-RSs. The UE may then select a subset of the multiple TRPs with which to communicate, and the UE may transmit an indication of the selected TRPs in a CSI report. In some cases, the UE may indicate a common subset of TRPs with which the UE may communicate on multiple layers, or the UE may indicate a respective subset of TRPs with which the UE may communicate on each layer of multiple layers. The UE may also provide additional information in the CSI report for the selected TRPs. The selected TRPs may then use the additional information provided in the CSI report to identify suitable configurations for communicating with the UE.

A method for wireless communication at a UE is described. The method may include receiving channel state information reference signals from a set of multiple transmission reception points, transmitting a channel state information report based on receiving the channel state information reference signals, the channel state information report indicating a subset of transmission reception points selected from the set of multiple transmission reception points for communications with the UE, and communicating with the subset of transmission reception points based on transmitting the channel state information report.

An apparatus for wireless communication is described. The apparatus may include a memory, a transceiver, and at least one processor of a UE, the at least one processor coupled with the memory and the transceiver. The at least one processor may be configured to receive channel state information reference signals from a set of multiple transmission reception points, transmit a channel state information report based on receiving the channel state information reference signals, the channel state information report indicating a subset of transmission reception points selected from the set of multiple transmission reception points for communications with the UE, and communicate with the subset of transmission reception points based on transmitting the channel state information report.

Another apparatus for wireless communication at a UE is described. The apparatus may include means for receiving channel state information reference signals from a set of multiple transmission reception points, means for transmitting a channel state information report based on receiving the channel state information reference signals, the channel state information report indicating a subset of transmission reception points selected from the set of multiple transmission reception points for communications with the UE, and means for communicating with the subset of transmission reception points based on transmitting the channel state information report.

A non-transitory computer-readable medium storing code for wireless communication at a UE is described. The code may include instructions executable by a processor to receive channel state information reference signals from a set of multiple transmission reception points, transmit a channel state information report based on receiving the channel state information reference signals, the channel state information report indicating a subset of transmission reception points selected from the set of multiple transmission reception points for communications with the UE, and communicate with the subset of transmission reception points based on transmitting the channel state information report.

Some examples of the method, apparatuses, and non-transitory computer-readable medium described herein may further include operations, features, means, or instructions for transmitting, in the channel state information report, a bitmap indicating the subset of transmission reception points for communications with the UE, where a size of the bitmap may be proportional to a quantity of the set of multiple transmission reception points.

In some examples of the method, apparatuses, and non-transitory computer-readable medium described herein, the bitmap indicates a common subset of transmission reception points for communications with the UE on a set of multiple layers. In some examples of the method, apparatuses, and non-transitory computer-readable medium described herein, the bitmap indicates a respective subset of transmission reception points for communications with the UE on each layer of a set of multiple layers.

Some examples of the method, apparatuses, and non-transitory computer-readable medium described herein may further include operations, features, means, or instructions for receiving an indication of a configuration for indicating, in the bitmap, a common subset of transmission reception points for communications with the UE on a first set of multiple layers or a respective subset of transmission reception points for communications with the UE on each layer of a second set of multiple layers.

Some examples of the method, apparatuses, and non-transitory computer-readable medium described herein may further include operations, features, means, or instructions for transmitting, in the channel state information report, a common selection of spatial domain bases for each transmission reception point of the subset of transmission reception points to use for communications with the UE on a set of multiple layers. Some examples of the method, apparatuses, and non-transitory computer-readable medium described herein may further include operations, features, means, or instructions for transmitting, in the channel state information report, a respective selection of spatial domain bases for each transmission reception point of the subset of transmission reception points to use for communications with the UE on each layer of a set of multiple layers.

In some examples of the method, apparatuses, and non-transitory computer-readable medium described herein, a quantity of spatial domain bases indicated in the channel state information report may be constant for each transmission reception point of the subset of transmission reception points. In some examples of the method, apparatuses, and non-transitory computer-readable medium described herein, a quantity of spatial domain bases indicated in the channel state information report for a transmission reception point of the subset of transmission reception points may be based on the transmission reception point.

Some examples of the method, apparatuses, and non-transitory computer-readable medium described herein may further include operations, features, means, or instructions for receiving an indication of a configuration of a total quantity of spatial domain bases to indicate in the channel state information report and transmitting, in the channel state information report, a quantity of spatial domain bases included in the channel state information report for each transmission reception point of the subset of transmission reception points.

Some examples of the method, apparatuses, and non-transitory computer-readable medium described herein may further include operations, features, means, or instructions for transmitting, in the channel state information report, a respective number of selected frequency domain bases for each layer of a set of multiple layers based on a quantity of transmission reception points selected for communications with the UE on the layer.

Some examples of the method, apparatuses, and non-transitory computer-readable medium described herein may further include operations, features, means, or instructions for transmitting, in the channel state information report for each layer of a set of multiple layers, a common selection of spatial domain bases for each transmission reception point of the subset of transmission reception points to use for communications with the UE.

Some examples of the method, apparatuses, and non-transitory computer-readable medium described herein may further include operations, features, means, or instructions for transmitting, in the channel state information report, selected non-zero coefficients for precoding for a first polarization at a first transmission reception point of the subset of transmission reception points, where the first polarization may be stronger than a second polarization at the first transmission reception point, transmitting, in the channel state information report, first two or more differential amplitudes between the selected non-zero coefficients and coefficients for precoding for a second polarization at each transmission reception point of the subset of transmission reception points, and transmitting, in the channel state information report, second one or more differential amplitudes between the selected non-zero coefficients and coefficients for precoding at each transmission reception point of the subset of transmission reception points excluding the first transmission reception point.

Some examples of the method, apparatuses, and non-transitory computer-readable medium described herein may further include operations, features, means, or instructions for transmitting, in the channel state information report, an indication of whether a first polarization or a second polarization may be stronger for each transmission reception point of the subset of transmission reception points.

Some examples of the method, apparatuses, and non-transitory computer-readable medium described herein may further include operations, features, means, or instructions for transmitting, in the channel state information report for a first transmission reception point of the subset of transmission reception points, selected non-zero coefficients for precoding for a first polarization at the first transmission reception point and transmitting, in the channel state information report for the first transmission reception point, one or more differential amplitudes between the selected non-zero coefficients and coefficients for precoding for a second polarization at the first transmission reception point.

In some examples of the method, apparatuses, and non-transitory computer-readable medium described herein, communicating with the subset of transmission reception points may include operations, features, means, or instructions for receiving a coherent joint transmission from the subset of transmission reception points, where phases of a set of multiple transmissions forming the coherent joint transmission may be controlled and coordinated by the subset of transmission reception points.

A method for wireless communication at a network entity is described. The method may include transmitting channel state information reference signals, receiving a channel state information report based on transmitting the channel state information reference signals, the channel state information report indicating a subset of transmission reception points selected from a set of multiple transmission reception points for communications with a UE, and communicating with the UE based on receiving the channel state information report.

An apparatus for wireless communication is described. The apparatus may include a memory, a transceiver, and at least one processor of a network entity, the at least one processor coupled with the memory and the transceiver. The at least one processor may be configured to transmit channel state information reference signals, receive a channel state information report based on transmitting the channel state information reference signals, the channel state information report indicating a subset of transmission reception points selected from a set of multiple transmission reception points for communications with a UE, and communicate with the UE based on receiving the channel state information report.

Another apparatus for wireless communication at a network entity is described. The apparatus may include means for transmitting channel state information reference signals, means for receiving a channel state information report based on transmitting the channel state information reference signals, the channel state information report indicating a subset of transmission reception points selected from a set of multiple transmission reception points for communications with a UE, and means for communicating with the UE based on receiving the channel state information report.

A non-transitory computer-readable medium storing code for wireless communication at a network entity is described. The code may include instructions executable by a processor to transmit channel state information reference signals, receive a channel state information report based on transmitting the channel state information reference signals, the channel state information report indicating a subset of transmission reception points selected from a set of multiple transmission reception points for communications with a UE, and communicate with the UE based on receiving the channel state information report.

Some examples of the method, apparatuses, and non-transitory computer-readable medium described herein may further include operations, features, means, or instructions for receiving, in the channel state information report, a bitmap indicating the subset of transmission reception points for communications with the UE, where a size of the bitmap may be proportional to a quantity of the set of multiple transmission reception points.

In some examples of the method, apparatuses, and non-transitory computer-readable medium described herein, the bitmap indicates a common subset of transmission reception points for communications with the UE on a set of multiple layers. In some examples of the method, apparatuses, and non-transitory computer-readable medium described herein, the bitmap indicates a respective subset of transmission reception points for communications with the UE on each layer of a set of multiple layers.

Some examples of the method, apparatuses, and non-transitory computer-readable medium described herein may further include operations, features, means, or instructions for transmitting an indication of a configuration for indicating, in the bitmap, a common subset of transmission reception points for communications with the UE on a first set of multiple layers or a respective subset of transmission reception points for communications with the UE on each layer of a second set of multiple layers.

Some examples of the method, apparatuses, and non-transitory computer-readable medium described herein may further include operations, features, means, or instructions for receiving, in the channel state information report, a common selection of spatial domain bases for each transmission reception point of the subset of transmission reception points to use for communications with the UE on a set of multiple layers. Some examples of the method, apparatuses, and non-transitory computer-readable medium described herein may further include operations, features, means, or instructions for receiving, in the channel state information report, a respective selection of spatial domain bases for each transmission reception point of the subset of transmission reception points to use for communications with the UE on each layer of a set of multiple layers.

In some examples of the method, apparatuses, and non-transitory computer-readable medium described herein, a quantity of spatial domain bases indicated in the channel state information report may be constant for each transmission reception point of the subset of transmission reception points. In some examples of the method, apparatuses, and non-transitory computer-readable medium described herein, a quantity of spatial domain bases indicated in the channel state information report for a transmission reception point of the subset of transmission reception points may be based on the transmission reception point.

Some examples of the method, apparatuses, and non-transitory computer-readable medium described herein may further include operations, features, means, or instructions for transmitting an indication of a configuration of a total quantity of spatial domain bases to indicate in the channel state information report and receiving, in the channel state information report, a quantity of spatial domain bases included in the channel state information report for each transmission reception point of the subset of transmission reception points.

Some examples of the method, apparatuses, and non-transitory computer-readable medium described herein may further include operations, features, means, or instructions for receiving, in the channel state information report, a respective number of selected frequency domain bases for each layer of a set of multiple layers based on a quantity of transmission reception points selected for communications with the UE on the layer.

Some examples of the method, apparatuses, and non-transitory computer-readable medium described herein may further include operations, features, means, or instructions for receiving, in the channel state information report for each layer of a set of multiple layers, a common selection of spatial domain bases for each transmission reception point of the subset of transmission reception points to use for communications with the UE.

Some examples of the method, apparatuses, and non-transitory computer-readable medium described herein may further include operations, features, means, or instructions for receiving, in the channel state information report, selected non-zero coefficients for precoding for a first polarization at a first transmission reception point of the subset of transmission reception points, where the first polarization may be stronger than a second polarization at the first transmission reception point, receiving, in the channel state information report, first two or more differential amplitudes between the selected non-zero coefficients and coefficients for precoding for a second polarization at each transmission reception point of the subset of transmission reception points, and receiving, in the channel state information report, second one or more differential amplitudes between the selected non-zero coefficients and coefficients for precoding at each transmission reception point of the subset of transmission reception points excluding the first transmission reception point.

Some examples of the method, apparatuses, and non-transitory computer-readable medium described herein may further include operations, features, means, or instructions for receiving, in the channel state information report, an indication of whether a first polarization or a second polarization may be stronger for each transmission reception point of the subset of transmission reception points.

Some examples of the method, apparatuses, and non-transitory computer-readable medium described herein may further include operations, features, means, or instructions for receiving, in the channel state information report for a first transmission reception point of the subset of transmission reception points, selected non-zero coefficients for precoding for a first polarization at the first transmission reception point and receiving, in the channel state information report for the first transmission reception point, one or more differential amplitudes between the selected non-zero coefficients and coefficients for precoding for a second polarization at the first transmission reception point.

In some examples of the method, apparatuses, and non-transitory computer-readable medium described herein, communicating with the UE may include operations, features, means, or instructions for transmitting at least one transmission in a set of multiple transmissions forming a coherent joint transmission to the UE, where phases of the set of multiple transmissions forming the coherent joint transmission may be controlled and coordinated by the subset of transmission reception points.

### BRIEF DESCRIPTION OF THE DRAWINGS

FIG. 1 illustrates an example of a wireless communications system that supports TRP selection for coherent joint transmissions in accordance with one or more aspects of the present disclosure.

FIG. 2 illustrates an example of non-coherent joint transmissions in accordance with one or more aspects of the present disclosure.

FIG. 3 illustrates an example of coherent joint transmissions in accordance with one or more aspects of the present disclosure.

FIG. 4 illustrates an example of orientations of different antenna panels used for coherent joint transmissions in accordance with one or more aspects of the present disclosure.

FIG. 5 illustrates an example of precoding matrices indicated in a channel state information (CSI) report for multiple layers in accordance with one or more aspects of the present disclosure.

FIG. 6 illustrates an example of a wireless communications system that supports TRP selection for coherent joint transmissions in accordance with one or more aspects of the present disclosure.

FIG. 7 illustrates an example of a layer-specific selection of spatial domain (SD) bases in accordance with one or more aspects of the present disclosure.

FIG. 8 illustrates an example of a process flow that supports TRP selection for coherent joint transmissions in accordance with one or more aspects of the present disclosure.

FIGS. 9 and 10 show block diagrams of devices that support TRP selection for coherent joint transmissions in accordance with one or more aspects of the present disclosure.

FIG. 11 shows a block diagram of a communications manager that supports TRP selection for coherent joint transmissions in accordance with one or more aspects of the present disclosure.

FIG. 12 shows a diagram of a system including a device that supports TRP selection for coherent joint transmissions in accordance with one or more aspects of the present disclosure.

FIGS. 13 and 14 show block diagrams of devices that support TRP selection for coherent joint transmissions in accordance with one or more aspects of the present disclosure.

FIG. 15 shows a block diagram of a communications manager that supports TRP selection for coherent joint transmissions in accordance with one or more aspects of the present disclosure.

FIG. 16 shows a diagram of a system including a device that supports TRP selection for coherent joint transmissions in accordance with one or more aspects of the present disclosure.

FIGS. 17 and 18 show flowcharts illustrating methods that support TRP selection for coherent joint transmissions in accordance with one or more aspects of the present disclosure.

### DETAILED DESCRIPTION

In some wireless communications systems, a user equipment (UE) may communicate with multiple transmission reception points (TRPs) to improve the reliability of communications. For instance, when operating in a multi-TRP operation mode, the UE may receive the same downlink data from multiple TRPs, resulting in improved reliability (e.g., a higher chance that the data is received by the UE). In such systems, the TRPs may transmit channel state information (CSI) reference signals (CSI-RSs) to the UE, and the UE may perform measurements on the CSI-RSs to identify suitable configurations for communicating with the TRPs. The UE may also transmit a CSI report to a network entity such that the network entity may identify suitable configurations at the TRPs for communicating with the UE. In some cases, however, as the number of TRPs with which the UE may be configured to communicate increases, the overhead of CSI reporting also increases, resulting in increased power consumption and processing at the UE in addition to inefficient utilization of resources.

As described herein, a wireless communications system may support efficient techniques at a UE for selecting TRPs with which to communicate to minimize the overhead of CSI reporting. A UE may receive CSI-RSs from multiple TRPs and may perform measurements on the CSI-RSs. The UE may then select a subset of the multiple TRPs with which to communicate, and the UE may transmit an indication of the selected TRPs in a CSI report. In some cases, the UE may indicate a common subset of TRPs with which the UE may communicate on multiple layers, or the UE may indicate a respective subset of TRPs with which the UE may communicate on each layer of multiple layers. The UE may also provide additional information in the CSI report for the selected TRPs. The selected TRPs may then use the additional information provided in the CSI report to identify suitable configurations for communicating with the UE.

Aspects of the disclosure are initially described in the context of wireless communications systems. Examples of processes and signaling exchanges that support TRP selection for coherent joint transmissions are then described. Aspects of the disclosure are further illustrated by and described with reference to apparatus diagrams, system diagrams, and flowcharts that relate to TRP selection for coherent joint transmissions.

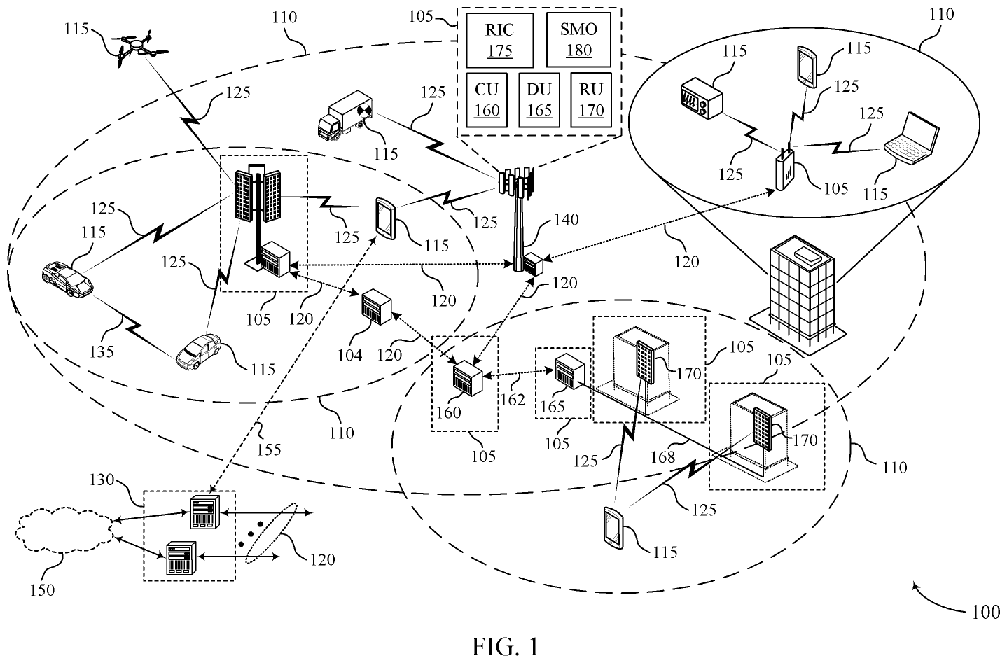

FIG. 1 illustrates an example of a wireless communications system 100 that supports TRP selection for coherent joint transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support TRP selection for coherent joint transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115 (e.g., in a physical downlink control channel (PDCCH) or a physical downlink shared channel (PDSCH)), uplink transmissions (e.g., return link transmissions) from a UE 115 to a network entity 105 (e.g., in a physical uplink control channel (PUCCH) or a physical uplink shared channel (PUSCH)), or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna array's within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The wireless communications system 100 may support multi-TRP communications with a UE 115 to improve the reliability of communications. For instance, when operating in a multi-TRP operation mode, the UE 115 may receive the same downlink data from multiple TRPs, resulting in improved reliability (e.g., a higher chance that the data is received by the UE 115). Multi-TRP transmissions may also be referred to as coordinated multipoint (COMP) transmissions including joint transmissions from multiple TRPs to a single UE 115. Multi-TRP transmissions or COMP transmissions may include coherent joint transmissions and non-coherent joint transmissions.

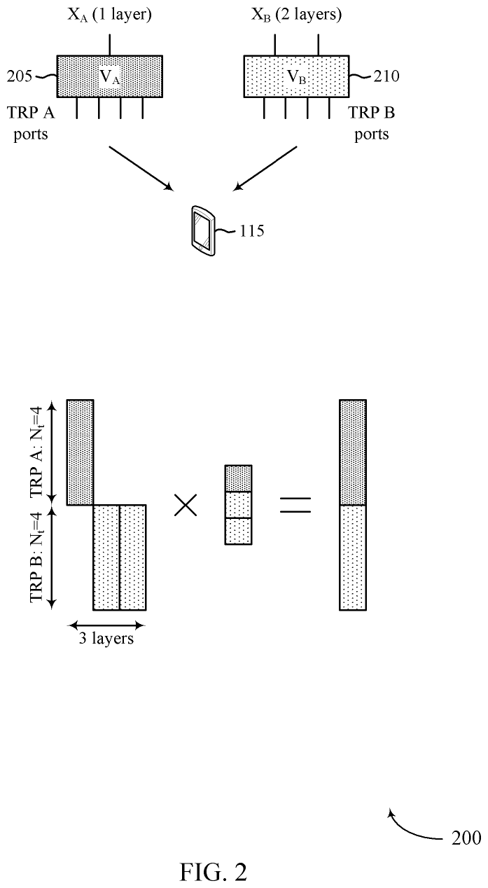

FIG. 2 illustrates an example of non-coherent joint transmissions 200 in accordance with one or more aspects of the present disclosure. Non-coherent joint transmissions may be based on spatial division multiplexing (SDM), and data may be precoded separately at different TRPs. A first TRP 205 may precode data X_{A} using a precoder V_{A}, and a second TRP 210 may precode data X_{B} using a precoder V_{B}. A precoder V (Nₜ^{TRP}×RI^{TRP}) used for precoding a data transmission at a TRP may be based on a number of transmit antennas at the TRP to be used for the data transmission and a rank of the data transmission (e.g., V_{A}:4×1, V_{B}:4×2). Further, the data X (RI^{TRP}×1) to be precoded for the data transmission from a TRP may be mapped to different layers based on a rank of the data transmission (e.g., X_{A}:1×1, X_{B}:2×1). Thus, the precoded data transmission from the first TRP 205 and the second TRP 305 may be given by equation 1.

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] \qquad ( 1 )$$

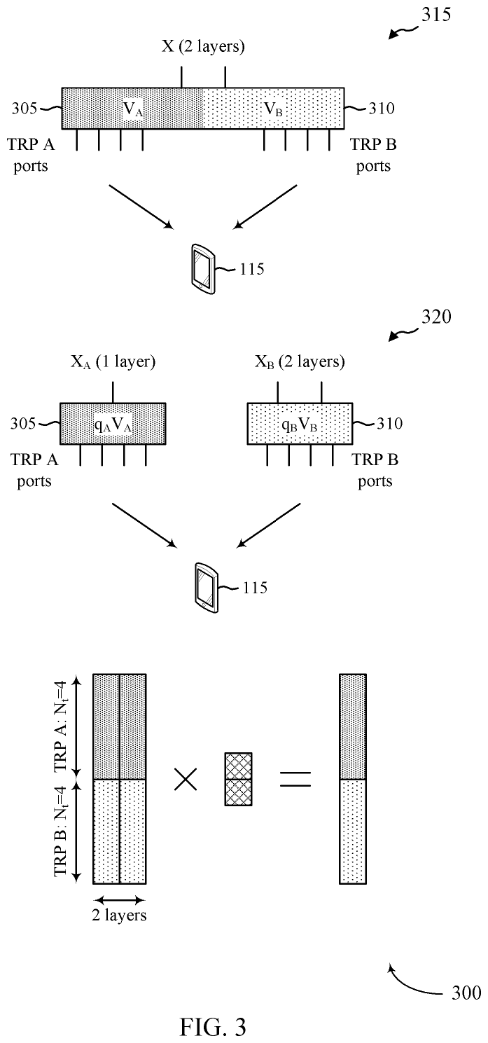

FIG. 3 illustrates an example of coherent joint transmissions 300 in accordance with one or more aspects of the present disclosure. Coherent joint transmissions may refer to transmissions including data that is jointly precoded at different TRPs or precoded separately at different TRPs with controlled phases and coefficients.

In a first example 315 of coherent joint transmissions, data may be jointly precoded at different TRPs (e.g., data is precoded in a fully, joint way). A first TRP 305 may precode data X using a precoder V_{A}, and a second TRP 310 may precode the data X using a precoder V_{B}. A precoder V (Nₜ^{TRP}×RI^{joint}) used for precoding a data transmission at a TRP may be based on a number of transmit antennas at the TRP to be used for the data transmission and a rank of the data transmission (e.g., V_{A}:4×2, V_{B}:4×2). Further, the data X (RI^{joint}×1) to be precoded for the data transmission from the first TRP 305 and the second TRP 310 may be mapped to different layers based on a rank of the data transmission (e.g., X_{A}:2×1). Thus, the precoded data transmission from the first TRP 305 and the second TRP 310 may be given by equation 2.

$$[ \begin{matrix}{V}_{A} \\ {V}_{B}\end{matrix} ] \cdot X = [ \begin{matrix}{V}_{A} X \\ {V}_{B} X\end{matrix} ] \qquad ( 2 )$$

In a second example 320 of coherent joint transmissions, data may be separately precoded at different TRPs (e.g., separate precoders), and the precoders may include co-phase or amplitude coefficients (e.g., q_{A}, q_{B}, or relatively as

$$q = \frac{{q}_{A}}{{q}_{B}} ) .$$

Thus, the precoded data transmission from the first TRP 305 and the second TRP 310 may be given by equation 3.

$$[ \begin{matrix}{q}_{A} {V}_{A} & 0 \\ 0 & {q}_{B} {V}_{B}\end{matrix} ] [ \begin{matrix}{X}_{A} \\ {X}_{B}\end{matrix} ] = [ \begin{matrix}{q}_{A} {V}_{A} {X}_{A} \\ {q}_{B} {V}_{B} {X}_{B}\end{matrix} ] , or [ \begin{matrix}{V}_{A} & 0 \\ 0 & {qV}_{B}\end{matrix} ] [ \begin{matrix}{X}_{A} \\ {X}_{B}\end{matrix} ] = [ \begin{matrix}{V}_{A} {X}_{A} \\ {qV}_{B} {X}_{B}\end{matrix} ] \qquad ( 3 )$$

In some cases, the co-phase or amplitude of a precoder may be implicitly included (e.g., accommodated). In such cases, equation 3 may be no different from equation 1 (e.g., for non-coherent joint transmissions).

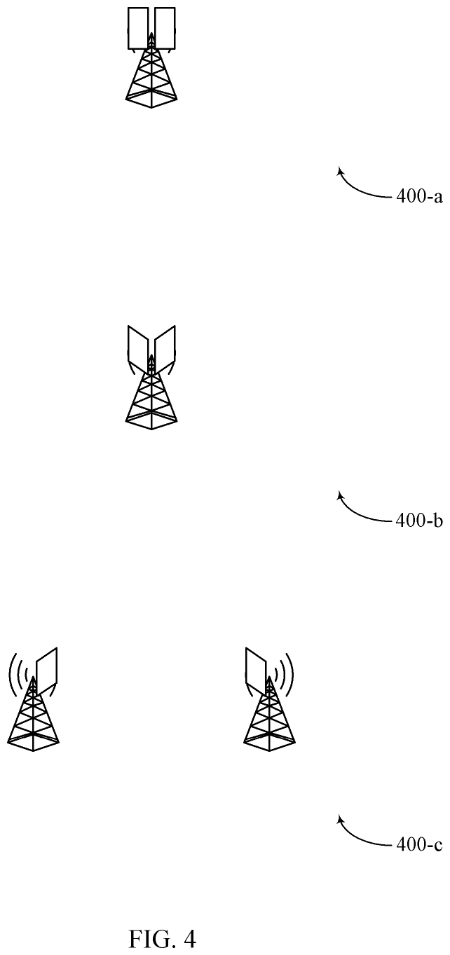

FIG. 4 illustrates an example of orientations of different antenna panels 400 used for coherent joint transmissions in accordance with one or more aspects of the present disclosure. One or more TRPs may support coherent joint transmissions with backhaul communications and synchronization among the TRPs. In one aspect, co-located TRPs or antenna panels (e.g., intra-site) may be used for coherent joint transmissions. In the example 400-a, a TRP may use multiple antenna panels with a same orientation for coherent joint transmissions. In the example 400-b, a TRP may use multiple antenna panels with different orientations (e.g., inter-sector) for coherent joint transmissions. In another aspect, distributed TRPs (e.g., inter-site) may be used for coherent joint transmissions. This aspect is depicted in the example 400-c.

If co-located TRPs or antenna panels are used for coherent joint transmissions, a precoding matrix or precoder used for precoding data may be selected from a joint codebook. Such a precoding matrix or precoder may be given by equation 4.

$$W = [ \begin{matrix}{W}_{1 , 0} & 0 \\ 0 & {W}_{1 , 1}\end{matrix} ] \times {\tilde{W}}_{2} \times {W}_{f}^{H} = [ \begin{matrix}{W}^{TRP \#0} \\ {W}^{TRP \#1}\end{matrix} ] \qquad ( 4 )$$

If distributed TRPs are used for coherent joint transmissions, precoding matrices or precoders used for precoding data may be selected from separate codebooks and a co-amplitude or phase coefficient may be added to the precoding matrices or precoders. Such a precoding matrix or precoder may be given by equation 5.

$$W = [ \begin{matrix}{W}^{TRP \#0} \\ {q}_{1} {W}^{TRP \#1}\end{matrix} ] = [ \begin{matrix}{W}_{1 , 0} \times {\tilde{W}}_{2 , 0} \times {W}_{f , 0}^{H} \\ {q}_{1} {W}_{1 , 1} \times {\tilde{W}}_{2 , 1} \times {W}_{f , 1}^{H}\end{matrix} ] = [ \begin{matrix}{W}_{1 , 0} & 0 \\ 0 & {W}_{1 , 1}\end{matrix} ] \times [ \begin{matrix}{\tilde{W}}_{2 , 0} & 0 \\ 0 & {q}_{1} {\tilde{W}}_{2 , 1}\end{matrix} ] \times [ \begin{matrix}{W}_{f , 0}^{H} \\ {W}_{f , 1}^{H}\end{matrix} ] \qquad ( 5 )$$

In some aspects, if a UE 115 is configured to communicate with multiple TRPs, the TRPs may transmit CSI-RSs to the UE 115, and the UE 115 may perform measurements on the CSI-RSs to identify suitable configurations for communicating with the TRPs. Thus, the UE 115 may monitor for CSI-RSs (e.g., type-II CSI) on CSI-RS resources for coherent joint transmissions. In an example, a UE 115 may be configured to monitor a single CSI-RS resource for CSI-RSs from port groups from different TRPs, or the UE 115 may be configured to monitor multiple CSI-RS resources for CSI-RSs from different TRPs. After performing measurements on the CSI-RSs, the UE 115 may transmit a CSI report indicating parameters or configurations for the TRPs to use to communicate with the UE 115. For instance, the UE 115 may indicate, in the CSI report, a precoding matrix for a layer (e.g., W=W₁×\tilde{W}₂×W_{f}^{H}).

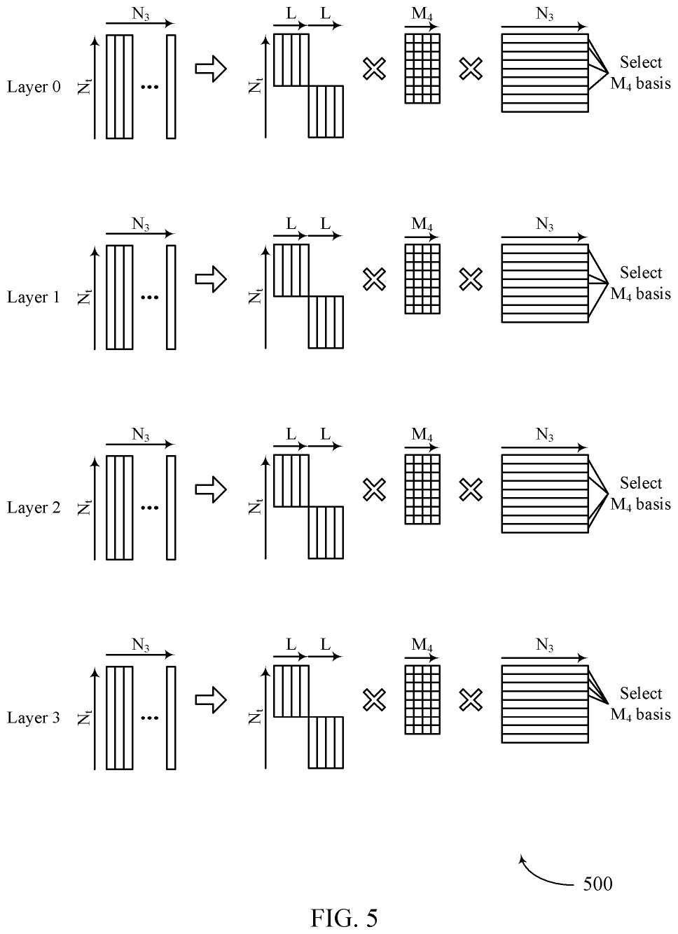

FIG. 5 illustrates an example of precoding matrices 500 indicated in a CSI report for multiple layers in accordance with one or more aspects of the present disclosure. A UE 115 may indicate precoding matrices for each of the multiple layers in the CSI report, and the CSI report may support up to a rank of four (i.e., four layers). For each layer, the precoder across a number of N₃ precoding matrix indicator (PMI) subbands may be a Nₜ×N₃ matrix W (e.g., W=W₁×\tilde{W}₂×W_{f}^{H}).

A number of PMI subbands N₃ may be determined by a number of channel quality indicator (CQI) subbands and a number of PMI subbands per CQI subband (e.g., R={1,2}). In some cases, a number of CQI subbands may be determined by a high layer parameter (e.g., csi-ReportingBand), and a number of PMI subbands per CQI subband may also be configured (e.g., by a parameter numberOfPMISubbandsPerCQISubband). For R=1, N₃ may be equal to a number of CQI subbands (e.g., with possible values {1, 2, . . . , 19}). For R=2, the possible values of N₃ may be {1, 2, . . . , 37}. In some cases, a PMI subband size may be finer than a CQI subband size (e.g., half), which may be better than the PMI subband size being equal to the CQI subband size. For an edge CQI subband, if a number of resource blocks is less than or equal to a nominal CQI subband size divided by two, a UE 115 may report one PMI. Alternatively, for an edge CQI subband, if a number of resource blocks is greater than a CSI subband size divided by two, a UE 115 may report two PMIs. For other CQI subbands, a UE 115 may report two PMIs.

Spatial domain (SD) bases W₁ (e.g., discrete Fourier transform (DFT) bases) in the matrix may be a Nₜ×2L matrix, where Nₜ may refer to a number of transmit antennas and L may refer to a number of beams. W₁ may be layer-common, Nₜ may be RRC configured (e.g., Nₜ=2N₁O₁N₂O₂, with O₁ and O₂ oversampling), and L may be RRC configured (e.g., L={2,4,6}).

Frequency domain (FD) bases W_{f} (e.g., DFT bases) may be an M×N₃ matrix, where M may refer to a number or quantity of FD bases. may be layer-specific, M may be rank-pair specific (e.g., M₁=M₂ for rank={1,2}, and M₃=M₄ for rank={3,4}, where M₁ or M₃ is RRC configured).

Coefficients \tilde{W}₂ may be a 2L×M matrix and may be layer-specific. For each layer, a UE 115 may report up to K₀ non-zero coefficients (NZCs), where K₀ is RRC configured. Across all layers, the UE 115 may report up to 2K₀ non-zero coefficients. Unreported coefficients may be set to zeros, and the UE 115 may quantize the \tilde{W}₂ coefficients before reporting.

For a layer l, a UE 115 may quantize NZCs of \tilde{W}_{2,l} (e.g., layer-independent quantization). The NZCs may be reported for two different polarizations for transmissions from a TRP. The UE 115 may report an index of a strongest coefficient (e.g., NZC), and the strongest coefficient may be used as a reference for a stronger polarization. The stronger polarization may refer to a polarization associated with the strongest coefficient, and the weaker polarization may be the other polarization. If the strongest coefficient is one, the UE 115 may not quantize the coefficient. The UE 115 may also report a reference power for a weaker polarization. The UE 115 may quantize the reference power with four bits from 0 dB with a −1.5 dB (in power) step size. The UE 115 may also report a differential amplitude for each coefficient. The UE 115 may quantize the differential amplitude with three bits from 0 dB with a −3 dB (in power) step size. The UE 115 may also report a phase quantization for each coefficient. The UE 115 may quantize the phase with a 16 phase shift keying (PSK) alphabet. Equation 6 shows an example of a matrix of coefficients \tilde{W}₂ (e.g., quantization of \tilde{W}₂ for Type-II CSI).

$$[ \begin{matrix}{p}_{ref} {p}_{0 , 0} {e}^{j {ϕ}_{0 , 0}} & {p}_{ref} {p}_{0 , 1} {e}^{j {ϕ}_{0 , 1}} & ⋯ & {p}_{ref} {p}_{0 , M - 1} {e}^{j {ϕ}_{0 , M - 1}} \\ {p}_{ref} {p}_{1 , 0} {e}^{j {ϕ}_{1 , 0}} & {p}_{ref} {p}_{1 , 1} {e}^{j {ϕ}_{1 , 1}} & ⋯ & {p}_{ref} {p}_{1 , M - 1} {e}^{j {ϕ}_{1 , M - 1}} \\ ⋮ & ⋮ & ⋱ & ⋮ \\ {p}_{ref} {p}_{L - 1 , 0} {e}^{j {ϕ}_{L - 1 , 0}} & {p}_{ref} {p}_{L - 1 , 1} {e}^{j {ϕ}_{L - 1 , 1}} & ⋯ & {p}_{ref} {p}_{L - 1 , M - 1} {e}^{j {ϕ}_{L - 1 , M - 1}} \\ 1 & {p}_{L , 1} {e}^{j {ϕ}_{L , 1}} & ⋯ & {p}_{L , M - 1} {e}^{j {ϕ}_{L , M - 1}} \\ {p}_{L + 1 , 0} {e}^{j {ϕ}_{L + 1 , 0}} & {p}_{L + 1 , 1} {e}^{j {ϕ}_{L + 1 , 1}} & ⋯ & {p}_{L + 1 , M - 1} {e}^{j {ϕ}_{L + 1 , M - 1}} \\ ⋮ & ⋮ & ⋱ & ⋮ \\ {p}_{2 L - 1 , 0} {e}^{j {ϕ}_{2 L - 1 , 0}} & {p}_{2 L - 1 , 1} {e}^{j {ϕ}_{2 L - 1 , 1}} & ⋯ & {p}_{2 L - 1 , M - 1} {e}^{j {ϕ}_{2 L - 1 , 0}}\end{matrix} ] \qquad ( 6 )$$

The number of SD bases, FD basis, and NZCs to be reported by a UE 115 may be given by Table 1.

TABLE 1
Number of SD bases, FD bases, and NZCs

| | | p_{ν} | | |
|---|---|---|---|---|
| paramCombination | L | ν ∈{1, 2} | ν ∈{3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ¼ | ¼ | ½ |
| 7 | 6 | ¼ | — | ½ |
| 8 | 6 | ¼ | — | ¾ |

For a number of spatial domain bases, L={2, 4, 6}. For a number of FD bases,

$${M}_{1} = {M}_{2} = ⌈ {p}_{1} \times \frac{{N}_{3}}{R} ⌉ and {M}_{3} = {M}_{4} = ⌈ {p}_{3} \times \frac{{N}_{3}}{R} ⌉ .$$

For a number of NZCs, K₀=┌β×2LM₁┐. A UE 115 may receive RRC signaling to configure a (e.g., 1 out of 8) combination of L, p₁, p₃, β.

As the number of TRPs with which a UE 115 may be configured to communicate increases, the overhead of CSI reporting also increases (e.g., since the UE 115 may report SD bases, FD bases, and precoding coefficients for each TRP). That is, CSI reporting overhead may increase with the number of TRPs (e.g., N_{TRP}). In some cases, however, it may be appropriate to enable communications with a large number of TRPs or large number of ports (e.g., for low-frequency bands with distributed TRPs or panels). For instance, for a single-TRP or panel with e.g., 32 ports an antenna array size may be too large for practical deployment. Thus, the wireless communications system 100 may support efficient techniques supporting communications with multiple TRPs while minimizing CSI reporting overhead.

In one aspect, a UE 115 and a network entity 105 in wireless communications system 100 may support TRP selection to remove some TRPs having worse channels which may not be worth selecting. As a result, the UE 115 may avoid reporting parameters for communicating with these TRPs in a CSI report, and the overhead of the CSI report may be reduced. Further, if one additional dimension (e.g., a TRP level) introduced, some basic reporting mechanisms in wireless communications system 100 may be enhanced across TRPs, including SD or FD basis selection and differential quantization of coefficients.

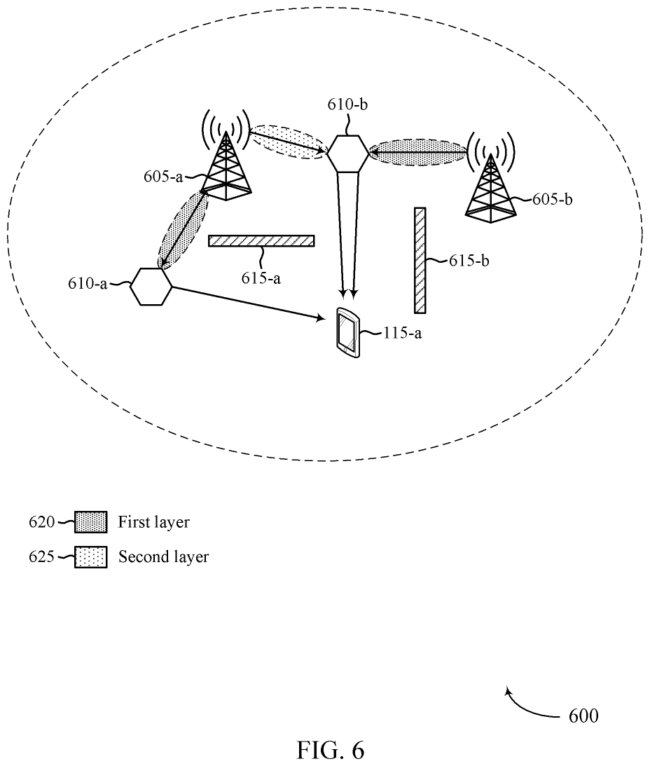

FIG. 6 illustrates an example of a wireless communications system 600 that supports TRP selection for coherent joint transmissions in accordance with one or more aspects of the present disclosure. The wireless communications system 600 includes a UE 115-a, which may be an example of a UE 115 described with reference to FIGS. 1-5. The wireless communications system 600 also includes a TRP 605-a and a TRP 605-b, which may be examples of TRPs or network entities 105 described with reference to FIGS. 1-5. The wireless communications system 600 may implement aspects of the wireless communications system 100. For example, the wireless communications system 600 may support efficient techniques for selecting TRPs for communications with the UE 115-a to minimize the overhead of CSI reporting.

The TRP 605-a may transmit CSI-RSs on one or more layers to the UE 115-a, and the TRP 605-b may transmit CSI-RSs on one or more layers to the UE 115-a. The UE 115-a may perform measurements on the CSI-RSs received from the TRP 605-a and the TRP 605-b, and the UE 115-a may use the measurements to select one or both of the TRPs 605 with which to communicate. The measurements may include reference signal received power (RSRP) measurements, a received signal strength indicator (RSSI), or signal-to-interference-plus-noise (SINR) measurements. In an example, if the measurements performed on CSI-RSs received from a TRP satisfy a threshold, the UE 115-a may select the TRP for coherent joint transmissions to the UE 115-b. Alternatively, if the measurements performed on CSI-RSs received from a TRP fail to satisfy a threshold, the UE 115-a may avoid selecting the TRP for coherent joint transmissions to the UE 115-b.

The UE 115-a may then indicate the selected TRPs in a CSI report. For example, the UE 115-a may indicate the TRPs based on measurements made on the CSI-RSs.

In some cases, the UE 115-a may select a common set of TRPs for communications on multiple layers (e.g., a layer-common selection). That is, the UE 115-a may select a same set of TRPs for communications on each layer of the multiple layers. In some examples, the UE 115-a may indicate the selected TRPs in a bitmap, and a size of the bitmap may be equal to the total number of TRPs (e.g., N_{TRP}) from which the UE 115-a is selecting the TRPs for communications. Each bit position in the bitmap may correspond to a different TRP. A bit value of one in the bitmap may indicate that a corresponding TRP is selected for communications with the UE 115-a, and a bit value of zero in the bitmap may indicate that a corresponding TRP is not selected for communications with the UE 115-a.

In other cases, the UE 115-a may select a respective set of TRPs for communications on each layer of multiple layers (e.g., a layer-specific selection or TRP-specific rank). For different layers, the UE 115-a may separately indicate the selection of TRPs in a CSI report. In some examples, the UE 115-a may indicate the selected TRPs in a bitmap, and a size of the bitmap may be equal to the total number of TRPs (e.g., N_{TRP}) from which the UE 115-a is selecting the TRPs for communications multiplied by the total number of the multiple layers (e.g., RI×N_{TRP}). Each bit position in the bitmap may correspond to a layer and a TRP. A bit value of one in the bitmap may indicate that a corresponding TRP is selected for communications with the UE 115-a on a corresponding layer, and a bit value of zero in the bitmap may indicate that a corresponding TRP is not selected for communications with the UE 115-a on a corresponding layer. Alternatively, for a first layer (e.g., layer #0), the UE 115-a may assume that all TRPs may be included or selected. Thus, no indication of TRPs may be provided in a CSI report, and a bitmap may have a size of (RI−1)×N_{TRP}.

In the example of FIG. 6, the UE 115-a may select the TRP 605-a for communications on a first layer 620 and a second layer 625, and the UE 115-a may select the TRP 605-b for communications on the first layer 620. The CSI-RSs from the first TRP 605-a on the first layer 620 may reflect off the cluster 610-a to the UE 115-a and may avoid the obstruction 615-a. The CSI-RSs from the first TRP 605-a on the second layer 625 may reflect off the cluster 610-b to the UE 115-a and may avoid the obstruction 615-a. The CSI-RSs from the second TRP 605-b on the first layer 620 may reflect off the cluster 610-b to the UE 115-a and may avoid the obstruction 615-b. Thus, the measurements of these CSI-RSs may satisfy a threshold, and the UE 115-a may select the first TRP 605-a for communications on the first layer 620 and the second layer 625 based on the measurements, and the UE 115-a may select the second TRP for communications on the first layer 620 based on the measurements. Table 2 illustrates an example of the TRP selection.

TABLE 2
Layer-specific TRP selection

| | TRP#0 | TRP#1 |
|---|---|---|
| Layer#0 | Selected (1) | Selected (1) |
| Layer#1 | Selected (1) | Not selected (0) |

In some cases, the UE 115-a may be configured to include either a layer-common TRP selection in a CSI report or a layer-specific TRP selection in the CSI report. If the UE 115-a is configured to include a layer-specific TRP selection in the CSI report, the number of selected SD or FD bases (e.g., the size of matrix W₁ or W_{f}) included in the CSI report may vary from layer to layer (e.g., increases with the total number of selected TRPs).

In addition to including the TRP selection in the CSI report, the UE 115-a may include an SD basis selection and FD basis selection across layers (e.g., layer x₁, x₂, . . . ) for a same TRP y (e.g., for each TRP).

In some cases, the UE 115-a may include a layer-common selection of SD bases in a CSI report for a same TRP. For example, the UE 115-a may report a same W_{1,y}^{layer #x} matrix for the layers x₁, x₂, . . . ) containing TRP y (e.g., while still allowing further SD basis selection by NZC selection). In other cases, the UE 115-a may include a layer-specific selection of SD bases in a CSI report for a same TRP. In one example, for a number of SD bases to select (e.g., 2L) the UE 115-a may include a constant number of SD bases for all TRPs in a CSI report (e.g., constant L for all TRPs). In another example, the UE 115-a may include a TRP-specific number of SD bases in a CSI report (e.g., TRP-specific L). In this example, the UE 115-a may be configured with a total number of SD bases to include in a CSI report, and the UE 115-a may indicate, in the CSI report, the selected number of SD bases for each TRP.

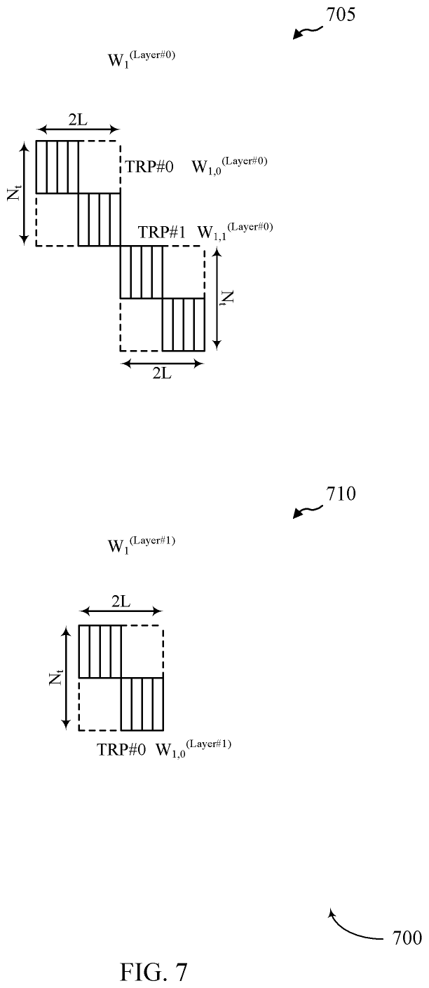

FIG. 7 illustrates an example of a layer-specific selection of SD bases 700 in accordance with one or more aspects of the present disclosure. In a first example 705, the UE 115-a may include a selection of SD bases in a CSI report for the first TRP 605-a and the second TRP 605-b for the first layer 620. In a second example 710, the UE 115-a may include a selection of SD bases in a CSI report for the first TRP 605-a for the second layer 625.

The UE 115-a may also include an FD bases selection in a CSI report. For an FD basis selection across layers (e.g., layer x₁, x₂, . . . ), the UE 115-a may include a layer-specific selection of FD bases in a same TRP. In other cases, for a layer x, the number of FD bases for a UE 115 to select (Mx) may be determined by a total number of TRPs selected for the layer x. For instance, the number of FD bases for the UE 115 to select may increase with the total number of selected TRPs (e.g., proportionally or disproportionately).

In some cases, in addition to, or as an alternative to, including an SD basis selection and an FD basis selection across layers for a same TRP y, the UE 115-a may include an SD basis selection and an FD basis selection within a layer x across TRPs (e.g., y₁, y₂, . . . ).

For SD basis selection within a layer x across TRPs, the UE 115-a may include a TRP-specific selection of SD bases or a TRP-common selection of SD bases. The TRP-specific selection of SD bases may include respective SD bases for each TRP of the TRPs selected by the UE 115-a for communications, and the TRP-common selection of SD bases may include common or the same SD bases for all TRPs selected by the UE 115-a for communications. In some cases, the TRP-specific selection may be appropriate for example 400-b or example 400-c, and the TRP-common selection may be appropriate for example 400-a (e.g., panels with the same orientation). The UE 115-a may be configured to include either a TRP-specific selection of SD bases or a TRP-common selection of SD bases in a CSI report (e.g., depending on whether the TRPs available for communicating with the UE 115-a are distributed or co-located TRPs).

For FD basis selection within a layer x across TRPs, the UE 115-a may include a TRP-specific selection of FD bases or a TRP-common selection of FD bases. The TRP-specific selection of FD bases may include respective FD bases for each TRP of the TRPs selected by the UE 115-a for communications, and the TRP-common selection of FD bases may include common or the same FD bases for all TRPs selected by the UE 115-a for communications. In some cases, the TRP-specific selection may be appropriate for example 400-c (e.g., with separate codebooks), and the TRP-common selection may be appropriate for example 400-a or example 400-b (e.g., with a joint codebook), since different TRPs may have close to the same path delays (e.g., in example 400-a) or delays spread within a same range (e.g., in example 400-b). The UE 115-a may be configured to include either a TRP-specific selection of FD bases or a TRP-common selection of FD bases in a CSI report.

In some cases, the UE 115-a may also be configured to include precoding coefficients in a CSI report (e.g., for either joint or separate codebooks for precoding). The UE 115-a may perform differential coefficient quantization within each layer to minimize the overhead of reporting the precoding coefficients in the CSI report. Further, the UE 115-a may include NZCs in the CSI report, and if no value is reported for a coefficient, a network entity 105 may determine that a value of the coefficient is zero. Thus, the reported precoding coefficients may be referred to as NZCs. In some cases, the UE 115-a may indicate, in a CSI report, a strongest coefficient across both of two polarizations and across all TRPs selected for communications.

In one example, after identifying a strongest coefficient across polarizations and across TRPs, the UE 115-a may identify a first polarization associated with the strongest coefficient and a first TRP associated with the strongest coefficient. The UE 115-a may then include, in a CSI report, the NZCs for precoding for the first polarization at the first TRP. These NZCs may be referred to as selected NZCs. In addition to the selected NZCs, the UE 115-a may include a first set of two or more differential amplitudes (e.g., P_{ref}^{pol} and p_{ref′}^{pol}) between the selected NZCs and other NZCs for precoding for a second polarization at the first TRP and at other TRPs (e.g., TRPs selected for communicating with the UE 115-a excluding the first TRP). Further, the UE 115-a may include a second set of one or more differential amplitudes (e.g., p_{ref}^{TRP}) between the selected NZCs and other NZCs for precoding at other TRPs. Thus, the UE 115-a may include, in a CSI report, two-level common-differential quantization for the amplitudes of NZCs (e.g., across the two polarizations P_{ref}^{pol} and p_{ref′}^{pol} and across TRPs (p_{ref}^{TRP})). In some cases, the UE 115-a may include an additional bit in the CSI report for each TRP (e.g., each TRP without a global SCI) indicating which polarization is stronger at the TRP. Equations 7 and 8 show the two-level common-differential quantization for the amplitudes of NZCs for two TRPs.

$$[ \begin{matrix}{p}_{ref}^{pol} {p}_{0 , 0} {e}^{j {ϕ}_{0 , 0}} & {p}_{ref}^{pol} {p}_{0 , 1} {e}^{j {ϕ}_{0 , 1}} & ⋯ & {p}_{ref}^{pol} {p}_{0 , M - 1} {e}^{j {ϕ}_{0 , M - 1}} \\ {p}_{ref}^{pol} {p}_{1 , 0} {e}^{j {ϕ}_{1 , 0}} & {p}_{ref}^{pol} {p}_{1 , 1} {e}^{j {ϕ}_{1 , 1}} & ⋯ & {p}_{ref}^{pol} {p}_{1 , M - 1} {e}^{j {ϕ}_{1 , M - 1}} \\ ⋮ & ⋮ & ⋱ & ⋮ \\ {p}_{ref}^{pol} {p}_{L - 1 , 0} {e}^{j {ϕ}_{L - 1 , 0}} & {p}_{ref}^{pol} {p}_{L - 1 , 1} {e}^{j {ϕ}_{L - 1 , 1}} & ⋯ & {p}_{ref}^{pol} {p}_{L - 1 , M - 1} {e}^{j {ϕ}_{L - 1 , M - 1}} \\ {p}_{L , 0} {e}^{j {ϕ}_{L , 0}} & {p}_{L , 1} {e}^{j {ϕ}_{L , 1}} & ⋯ & {p}_{L , M - 1} {e}^{j {ϕ}_{L , M - 1}} \\ {p}_{L + 1 , 0} {e}^{j {ϕ}_{L + 1 , 0}} & {p}_{L + 1 , 1} {e}^{j {ϕ}_{L + 1 , 1}} & ⋯ & {p}_{L + 1 , M - 1} {e}^{j {ϕ}_{L + 1 , M - 1}} \\ ⋮ & ⋮ & ⋱ & ⋮ \\ {p}_{2 L - 1 , 0} {e}^{j {ϕ}_{2 L - 1 , 0}} & {p}_{2 L - 1 , 1} {e}^{j {ϕ}_{2 L - 1 , 1}} & ⋯ & {p}_{2 L - 1 , M - 1} {e}^{j {ϕ}_{2 L - 1 , M - 1}}\end{matrix} ] \qquad ( 7 )$$

$$[ \begin{matrix}{p}_{{ref}^{′}}^{pol} {p}_{ref}^{TRP} {p}_{0 , 0}^{′} {e}^{j {ϕ}_{0 , 0}} & {p}_{{ref}^{′}}^{pol} {p}_{ref}^{TRP} {p}_{0 , 1}^{′} {e}^{j {ϕ}_{0 , 1}} & ⋯ & {p}_{{ref}^{′}}^{pol} {p}_{ref}^{TRP} {p}_{0 , M - 1}^{′} {e}^{j {ϕ}_{0 , M - 1}} \\ {p}_{{ref}^{′}}^{pol} {p}_{ref}^{TRP} {p}_{1 , 0}^{′} {e}^{j {ϕ}_{1 , 0}} & {p}_{{ref}^{′}}^{pol} {p}_{ref}^{TRP} {p}_{1 , 1}^{′} {e}^{j {ϕ}_{1 , 1}} & ⋯ & {p}_{{ref}^{′}}^{pol} {p}_{ref}^{TRP} {p}_{1 , M - 1}^{′} {e}^{j {ϕ}_{1 , M - 1}} \\ ⋮ & ⋮ & ⋱ & ⋮ \\ {p}_{{ref}^{′}}^{pol} {p}_{ref}^{TRP} {p}_{L - 1 , 0}^{′} {e}^{j {ϕ}_{L - 1 , 0}} & {p}_{{ref}^{′}}^{pol} {p}_{ref}^{TRP} {p}_{L - 1 , 1}^{′} {e}^{j {ϕ}_{L - 1 , 1}} & ⋯ & {p}_{{ref}^{′}}^{pol} {p}_{ref}^{TRP} {p}_{L - 1 , M - 1}^{′} {e}^{j {ϕ}_{L - 1 , M - 1}} \\ {p}_{ref}^{TRP} {p}_{L , 0}^{′} {e}^{j {ϕ}_{L , 0}} & {p}_{ref}^{TRP} {p}_{L , 1}^{′} {e}^{j {ϕ}_{L , 1}} & ⋯ & {p}_{ref}^{TRP} {p}_{L , M - 1}^{′} {e}^{j {ϕ}_{L , M - 1}} \\ {p}_{ref}^{TRP} {p}_{L + 1 , 0}^{′} {e}^{j {ϕ}_{L + 1 , 0}} & {p}_{ref}^{TRP} {p}_{L + 1 , 1}^{′} {e}^{j {ϕ}_{L + 1 , 1}} & ⋯ & {p}_{ref}^{TRP} {p}_{L + 1 , M - 1}^{′} {e}^{j {ϕ}_{L + 1 , M - 1}} \\ ⋮ & ⋮ & ⋱ & ⋮ \\ {p}_{ref}^{TRP} {p}_{2 L - 1 , 0}^{′} {e}^{j {ϕ}_{2 L - 1 , 0}} & {p}_{ref}^{TRP} {p}_{2 L - 1 , 1}^{′} {e}^{j {ϕ}_{2 L - 1 , 1}} & ⋯ & {p}_{ref}^{TRP} {p}_{2 L - 1 , M - 1}^{′} {e}^{j {ϕ}_{2 L - 1 , M - 1}}\end{matrix} ] \qquad ( 8 )$$

In another example, after identifying a strongest coefficient across polarizations and across TRPs, the UE 115-a may identify a first polarization associated with the strongest coefficient. The UE 115-a may then include, in a CSI report for each TRP selected for communications with the UE 115-a, the NZCs for precoding for the first polarization at the first TRP. These NZCs may be referred to as selected NZCs. In addition to the selected NZCs, the UE 115-a may include, in a CSI report for each TRP selected for communications with the UE 115-a, differential amplitudes (e.g., P_{ref}^{pol} and p_{ref′}^{pol}) between the selected NZCs for precoding for a second polarization at each TRP. Thus, the UE 115-a may include, in a CSI report, differential amplitudes across two polarizations (e.g., direct differential quantization for amplitudes with respect to the global strongest coefficient for a same polarization across TRPs). For both two-level common-differential quantization for the amplitudes of NZCs and direct differential quantization for the amplitudes of NZCs, the values of the differential amplitudes across polarizations (e.g., P_{ref}^{pol} and p_{ref′}^{pol}) may be the same or different. Equations 9 and 10 show the direct differential quantization for the amplitudes of NZCs for two TRPs.

$$[ \begin{matrix}{p}_{ref}^{pol} {p}_{0 , 0} {e}^{j {ϕ}_{0 , 0}} & {p}_{ref}^{pol} {p}_{0 , 1} {e}^{j {ϕ}_{0 , 1}} & ⋯ & {p}_{ref}^{pol} {p}_{0 , M - 1} {e}^{j {ϕ}_{0 , M - 1}} \\ {p}_{ref}^{pol} {p}_{1 , 0} {e}^{j {ϕ}_{1 , 0}} & {p}_{ref}^{pol} {p}_{1 , 1} {e}^{j {ϕ}_{1 , 1}} & ⋯ & {p}_{ref}^{pol} {p}_{1 , M - 1} {e}^{j {ϕ}_{1 , M - 1}} \\ ⋮ & ⋮ & ⋱ & ⋮ \\ {p}_{ref}^{pol} {p}_{L - 1 , 0} {e}^{j {ϕ}_{L - 1 , 0}} & {p}_{ref}^{pol} {p}_{L - 1 , 1} {e}^{j {ϕ}_{L - 1 , 1}} & ⋯ & {p}_{ref}^{pol} {p}_{L - 1 , M - 1} {e}^{j {ϕ}_{L - 1 , M - 1}} \\ {p}_{L , 0} {e}^{j {ϕ}_{L , 0}} & {p}_{L , 1} {e}^{j {ϕ}_{L , 1}} & ⋯ & {p}_{L , M - 1} {e}^{j {ϕ}_{L , M - 1}} \\ {p}_{L + 1 , 0} {e}^{j {ϕ}_{L + 1 , 0}} & {p}_{L + 1 , 1} {e}^{j {ϕ}_{L + 1 , 1}} & ⋯ & {p}_{L + 1 , M - 1} {e}^{j {ϕ}_{L + 1 , M - 1}} \\ ⋮ & ⋮ & ⋱ & ⋮ \\ {p}_{2 L - 1 , 0} {e}^{j {ϕ}_{2 L - 1 , 0}} & {p}_{2 L - 1 , 1} {e}^{j {ϕ}_{2 L - 1 , 1}} & ⋯ & {p}_{2 L - 1 , M - 1} {e}^{j {ϕ}_{2 L - 1 , M - 1}}\end{matrix} ] \qquad ( 9 )$$

$$[ \begin{matrix}{p}_{{ref}^{′}}^{pol} {p}_{0 , 0}^{′} {e}^{j {ϕ}_{0 , 0}} & {p}_{{ref}^{′}}^{pol} {p}_{0 , 1}^{′} {e}^{j {ϕ}_{0 , 1}} & ⋯ & {p}_{{ref}^{′}}^{pol} {p}_{0 , M - 1}^{′} {e}^{j {ϕ}_{0 , M - 1}} \\ {p}_{{ref}^{′}}^{pol} {p}_{1 , 0}^{′} {e}^{j {ϕ}_{1 , 0}} & {p}_{{ref}^{′}}^{pol} {p}_{1 , 1}^{′} {e}^{j {ϕ}_{1 , 1}} & ⋯ & {p}_{{ref}^{′}}^{pol} {p}_{1 , M - 1}^{′} {e}^{j {ϕ}_{1 , M - 1}} \\ ⋮ & ⋮ & ⋱ & ⋮ \\ {p}_{{ref}^{′}}^{pol} {p}_{L - 1 , 0}^{′} {e}^{j {ϕ}_{L - 1 , 0}} & {p}_{{ref}^{′}}^{pol} {p}_{L - 1 , 1}^{′} {e}^{j {ϕ}_{L - 1 , 1}} & ⋯ & {p}_{{ref}^{′}}^{pol} {p}_{L - 1 , M - 1}^{′} {e}^{j {ϕ}_{L - 1 , M - 1}} \\ {p}_{L , 0}^{′} {e}^{j {ϕ}_{L , 0}} & {p}_{L , 1}^{′} {e}^{j {ϕ}_{L , 1}} & ⋯ & {p}_{L , M - 1}^{′} {e}^{j {ϕ}_{L , M - 1}} \\ {p}_{L + 1 , 0}^{′} {e}^{j {ϕ}_{L + 1 , 0}} & {p}_{L + 1 , 1}^{′} {e}^{j {ϕ}_{L + 1 , 1}} & ⋯ & {p}_{L + 1 , M - 1}^{′} {e}^{j {ϕ}_{L + 1 , M - 1}} \\ ⋮ & ⋮ & ⋱ & ⋮ \\ {p}_{2 L - 1 , 0}^{′} {e}^{j {ϕ}_{2 L - 1 , 0}} & {p}_{2 L - 1 , 1}^{′} {e}^{j {ϕ}_{2 L - 1 , 1}} & ⋯ & {p}_{2 L - 1 , M - 1}^{′} {e}^{j {ϕ}_{2 L - 1 , M - 1}}\end{matrix} ] \qquad ( 10 )$$

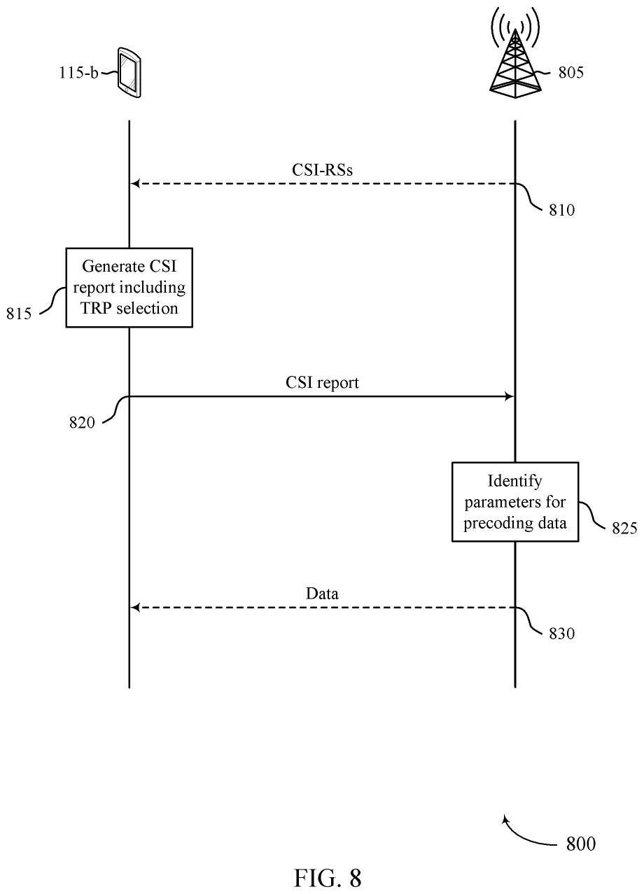

FIG. 8 illustrates an example of a process flow 800 that supports TRP selection for coherent joint transmissions in accordance with one or more aspects of the present disclosure. Process flow 800 includes a UE 115-b, which may be an example of a UE 115 described with reference to FIGS. 1-7. The process flow 800 also includes a network entity 805, which may be an example of a TRP or a network entity 105 described with reference to FIGS. 1-7. The process flow 800 may implement aspects of the wireless communications system 600. For example, the process flow 800 may support efficient techniques for selecting TRPs for communications with the UE 115-b to minimize the overhead of CSI reporting.

In the following description of the process flow 800, the signaling exchanged between the UE 115-b and the network entity 805 may be exchanged in a different order than the example order shown, or the operations performed by the UE 115-b and the network entity 805 may be performed in different orders or at different times. Some operations may also be omitted from the process flow 800, and other operations may be added to the process flow 800.

At 810, the network entity 805 may transmit CSI-RSs to the UE 115-b. The network entity 805 may be a TRP that may contribute to a coherent joint transmission to the UE 115-b, or the network entity 805 may coordinate coherent joint transmissions from multiple TRPs to the UE 115-b, for example, as shown with reference to FIGS. 3 and 4. The UE 115-b may receive the CSI-RSs from the network entity 805 and/or other network entities. That is, the UE 115-b may receive CSI-RSs from multiple TRPs. At 815, the UE 115-b may generate a CSI report including a TRP selection for transmission to the network entity 805, and, at 820, the UE 115-b may transmit the CSI report to the network entity 805. For instance, the UE 115-b may transmit, and the network entity 805 may receive, a CSI report based on the CSI-RSs received from multiple TRPs, and the CSI report may indicate a subset of TRPs selected from the multiple TRPs for communications with the UE 115-b, for example, as shown with reference to FIG. 6. The CSI report may also indicate additional information for the selected subset of TRPs, for example, as shown with reference to FIG. 5.

In some cases, the UE 115-b may include, in the CSI report, a bitmap indicating the subset of TRPs for communications with the UE 115-b. A size of the bitmap may be proportional to a quantity of the multiple TRPs from which the subset of TRPs is selected. In some cases, the size of the bitmap may be equal to a quantity of the multiple TRPs from which the subset of TRPs is selected. In some cases, the bitmap may indicate a common subset of TRPs for communications with the UE 115-b on multiple layers. In other cases, the bitmap may indicate a respective subset of TRPs for communications with the UE 115-b on each layer of multiple layers. In some cases, the network entity 805 may transmit, and the UE 115-b may receive, an indication of a configuration for indicating, in the bitmap, a common subset of TRPs for communications with the UE 115-b on a first set of layers or a respective subset of TRPs for communications with the UE 115-b on each layer of a second set of layers.

In some cases, the UE 115-b may include, in the CSI report, a common selection of SD bases for each TRP of the subset of TRPs to use for communications with the UE 115-b on multiple layers. In other cases, the UE 115-b may include, in the CSI report, a respective selection of SD bases for each TRP of the subset of TRPs to use for communications with the UE 115-b on each layer of multiple layers, for example, as shown with reference to FIG. 7. In some cases, a quantity of SD bases indicated in the CSI report may be constant for each TRP of the subset of TRPs. In some cases, a quantity of SD bases indicated in the CSI report for a TRP of the subset of TRPs may be based on the TRP. In some cases, the network entity 805 may transmit, and the UE 115-b may receive, an indication of a configuration of a total quantity of SD bases for the UE 115-b to indicate in the CSI report. In such cases, the UE 115-b may indicate, in the CSI report, a quantity of SD bases included in the CSI report for each TRP of the subset of TRPs. In some cases, the UE 115-b may include, in the CSI report for each layer of multiple layers, a common selection of SD bases for each TRP of the subset of TRPs to use for communications with the UE 115-b.

In some cases, the UE 115-b may include, in the CSI report, selected NZCs for precoding for a first polarization at a first TRP of the subset of TRPs, for example, as shown with reference to FIG. 5. The first polarization may be stronger than a second polarization at the first TRP. The UE 115-b may also include, in the CSI report, first two or more differential amplitudes between the selected NZCs and coefficients for precoding for a second polarization at each TRP of the subset of TRPs. The UE 115-b may also include, in the CSI report, second one or more differential amplitudes between the selected NZCs and coefficients for precoding at each TRP of the subset of TRPs excluding the first TRP. The UE 115-b may also include, in the CSI report, an indication of whether a first polarization or a second polarization is stronger for each TRP of the subset of TRPs. In some cases, the UE 115-b may include, in the CSI report for each TRP of the subset of TRPs, selected NZCs for precoding for a first polarization at the TRP. The UE 115-b may also include, in the CSI report for the each TRP, one or more differential amplitudes between the selected NZCs and coefficients for precoding for a second polarization at each TRP.

At 825, the network entity 805 may identify parameters for precoding data for transmission to the UE 115-b based on the CSI report, for example, as shown with reference to FIG. 5. For instance, the network entity 805 may identify a precoder for precoding data transmissions to the UE 115-b based on the SD bases, FD bases, and NZCs included in the CSI report. The network entity 805 may then precode data for transmission to the UE 115-b using the precoder, and, at 830, the network entity 805 may transmit data to the UE 115-b. For instance, the network entity 805 may transmit at least one transmission in multiple transmissions forming a coherent joint transmission to the UE 115-b. The phases and amplitudes of the multiple transmissions forming the coherent joint transmission may be controlled and coordinated by the TRPs participating in the coherent joint transmission. Alternatively, the network entity 805 may coordinate a coherent joint transmission of the data to the UE 115-b. In any case, the UE 115-b may receive the coherent joint transmission from multiple TRPs.

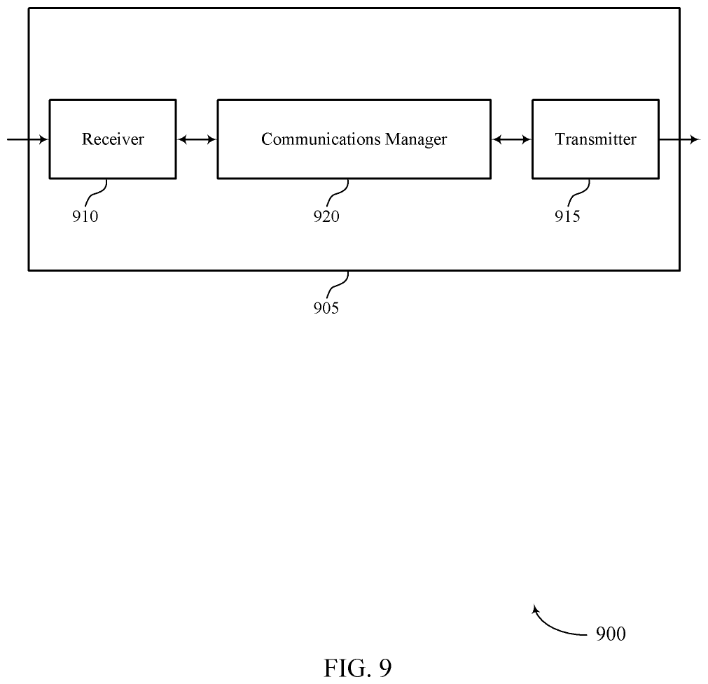

FIG. 9 shows a block diagram 900 of a device 905 that supports TRP selection for coherent joint transmissions in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to TRP selection for coherent joint transmissions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to TRP selection for coherent joint transmissions). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of TRP selection for coherent joint transmissions as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. For example, the communications manager 920 may be configured as or otherwise support a means for receiving channel state information reference signals from a set of multiple transmission reception points. The communications manager 920 may be configured as or otherwise support a means for transmitting a channel state information report based on receiving the channel state information reference signals, the channel state information report indicating a subset of transmission reception points selected from the set of multiple transmission reception points for communications with the UE. The communications manager 920 may be configured as or otherwise support a means for communicating with the subset of transmission reception points based on transmitting the channel state information report.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources. In particular, because the device 905 may select a subset of TRPs with which to communicate from a set of TRPs, the device 905 may transmit parameters for communicating with the subset of TRPs in a CSI report, and the device 905 may avoid transmitting some parameters for other TRPs in the set of TRPs. Thus, the device 905 may expend less power and processing to generate the CSI report (e.g., resulting in the reduced processing and power consumption), and the device 905 may use less resources to transmit the CSI report (e.g., resulting in the more efficient utilization of communication resources).

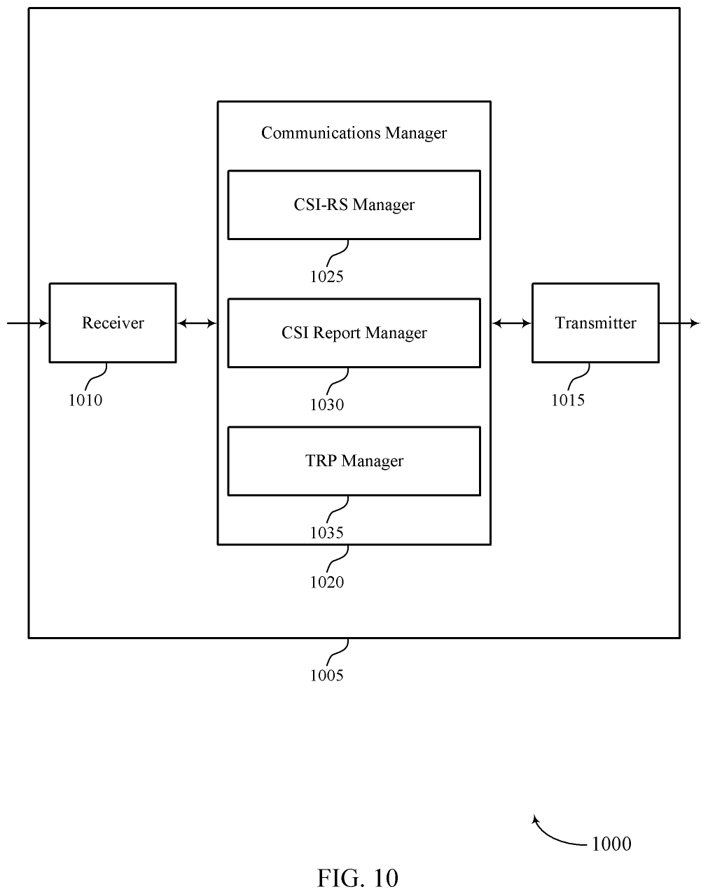

FIG. 10 shows a block diagram 1000 of a device 1005 that supports TRP selection for coherent joint transmissions in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to TRP selection for coherent joint transmissions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to TRP selection for coherent joint transmissions). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of TRP selection for coherent joint transmissions as described herein. For example, the communications manager 1020 may include a CSI-RS manager 1025, a CSI report manager 1030, an TRP manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The CSI-RS manager 1025 may be configured as or otherwise support a means for receiving channel state information reference signals from a set of multiple transmission reception points. The CSI report manager 1030 may be configured as or otherwise support a means for transmitting a channel state information report based on receiving the channel state information reference signals, the channel state information report indicating a subset of transmission reception points selected from the set of multiple transmission reception points for communications with the UE. The TRP manager 1035 may be configured as or otherwise support a means for communicating with the subset of transmission reception points based on transmitting the channel state information report.

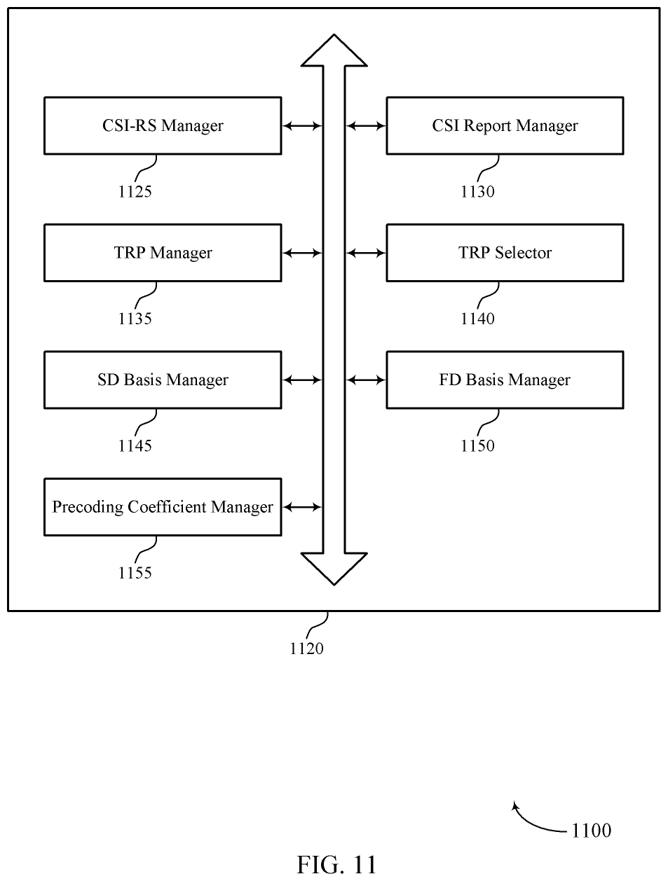

FIG. 11 shows a block diagram 1100 of a communications manager 1120 that supports TRP selection for coherent joint transmissions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of TRP selection for coherent joint transmissions as described herein. For example, the communications manager 1120 may include a CSI-RS manager 1125, a CSI report manager 1130, an TRP manager 1135, an TRP selector 1140, an SD basis manager 1145, an FD basis manager 1150, a precoding coefficient manager 1155, or any combination thereof. Each of these components may communicate, directly or indirectly, with one another (e.g., via one or more buses).

The communications manager 1120 may support wireless communication at a UE in accordance with examples as disclosed herein. The CSI-RS manager 1125 may be configured as or otherwise support a means for receiving channel state information reference signals from a set of multiple transmission reception points. The CSI report manager 1130 may be configured as or otherwise support a means for transmitting a channel state information report based on receiving the channel state information reference signals, the channel state information report indicating a subset of transmission reception points selected from the set of multiple transmission reception points for communications with the UE. The TRP manager 1135 may be configured as or otherwise support a means for communicating with the subset of transmission reception points based on transmitting the channel state information report.

In some examples, the TRP selector 1140 may be configured as or otherwise support a means for transmitting, in the channel state information report, a bitmap indicating the subset of transmission reception points for communications with the UE, where a size of the bitmap is proportional to a quantity of the set of multiple transmission reception points.

In some examples, the bitmap indicates a common subset of transmission reception points for communications with the UE on a set of multiple layers.

In some examples, the bitmap indicates a respective subset of transmission reception points for communications with the UE on each layer of a set of multiple layers.

In some examples, the CSI report manager 1130 may be configured as or otherwise support a means for receiving an indication of a configuration for indicating, in the bitmap, a common subset of transmission reception points for communications with the UE on a first set of multiple layers or a respective subset of transmission reception points for communications with the UE on each layer of a second set of multiple layers.

In some examples, the SD basis manager 1145 may be configured as or otherwise support a means for transmitting, in the channel state information report, a common selection of spatial domain bases for each transmission reception point of the subset of transmission reception points to use for communications with the UE on a set of multiple layers.

In some examples, the SD basis manager 1145 may be configured as or otherwise support a means for transmitting, in the channel state information report, a respective selection of spatial domain bases for each transmission reception point of the subset of transmission reception points to use for communications with the UE on each layer of a set of multiple layers.

In some examples, a quantity of spatial domain bases indicated in the channel state information report is constant for each transmission reception point of the subset of transmission reception points.

In some examples, a quantity of spatial domain bases indicated in the channel state information report for a transmission reception point of the subset of transmission reception points is based on the transmission reception point.

In some examples, the CSI report manager 1130 may be configured as or otherwise support a means for receiving an indication of a configuration of a total quantity of spatial domain bases to indicate in the channel state information report. In some examples, the SD basis manager 1145 may be configured as or otherwise support a means for transmitting, in the channel state information report, a quantity of spatial domain bases included in the channel state information report for each transmission reception point of the subset of transmission reception points.

In some examples, the FD basis manager 1150 may be configured as or otherwise support a means for transmitting, in the channel state information report, a respective number of selected frequency domain bases for each layer of a set of multiple layers based on a quantity of transmission reception points selected for communications with the UE on the layer.

In some examples, the SD basis manager 1145 may be configured as or otherwise support a means for transmitting, in the channel state information report for each layer of a set of multiple layers, a common selection of spatial domain bases for each transmission reception point of the subset of transmission reception points to use for communications with the UE.

In some examples, the precoding coefficient manager 1155 may be configured as or otherwise support a means for transmitting, in the channel state information report, selected non-zero coefficients for precoding for a first polarization at a first transmission reception point of the subset of transmission reception points, where the first polarization is stronger than a second polarization at the first transmission reception point. In some examples, the precoding coefficient manager 1155 may be configured as or otherwise support a means for transmitting, in the channel state information report, first two or more differential amplitudes between the selected non-zero coefficients and coefficients for precoding for a second polarization at each transmission reception point of the subset of transmission reception points. In some examples, the precoding coefficient manager 1155 may be configured as or otherwise support a means for transmitting, in the channel state information report, second one or more differential amplitudes between the selected non-zero coefficients and coefficients for precoding at each transmission reception point of the subset of transmission reception points excluding the first transmission reception point.

In some examples, the precoding coefficient manager 1155 may be configured as or otherwise support a means for transmitting, in the channel state information report, an indication of whether a first polarization or a second polarization is stronger for each transmission reception point of the subset of transmission reception points.

In some examples, the precoding coefficient manager 1155 may be configured as or otherwise support a means for transmitting, in the channel state information report for a first transmission reception point of the subset of transmission reception points, selected non-zero coefficients for precoding for a first polarization at the first transmission reception point. In some examples, the precoding coefficient manager 1155 may be configured as or otherwise support a means for transmitting, in the channel state information report for the first transmission reception point, one or more differential amplitudes between the selected non-zero coefficients and coefficients for precoding for a second polarization at the first transmission reception point.

In some examples, to support communicating with the subset of transmission reception points, the TRP manager 1135 may be configured as or otherwise support a means for receiving a coherent joint transmission from the subset of transmission reception points, where phases of a set of multiple transmissions forming the coherent joint transmission are controlled and coordinated by the subset of transmission reception points.

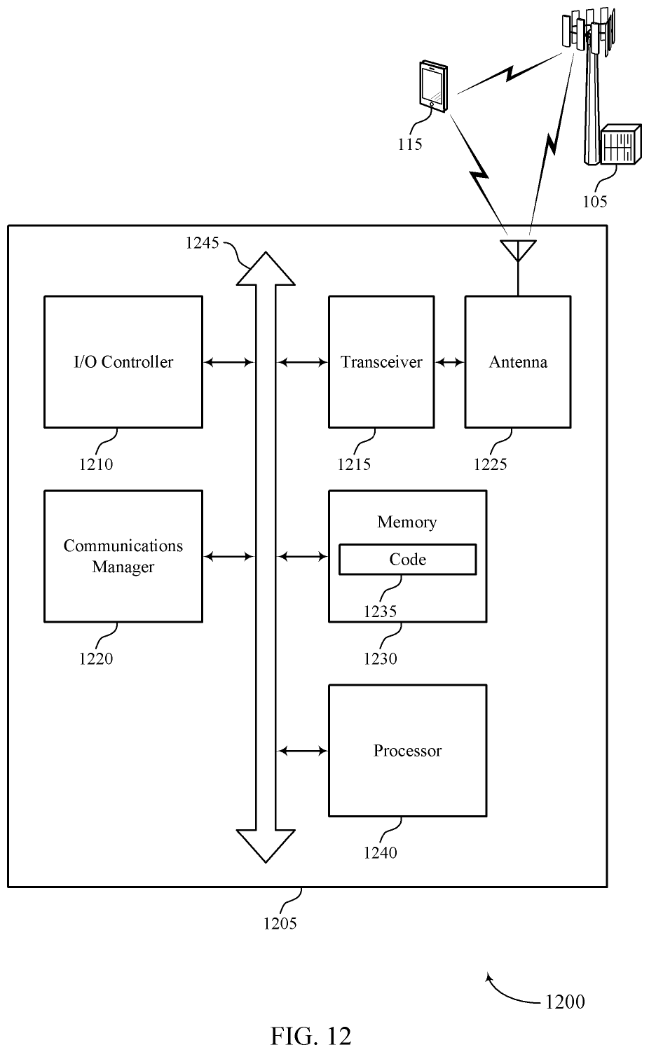

FIG. 12 shows a diagram of a system 1200 including a device 1205 that supports TRP selection for coherent joint transmissions in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting TRP selection for coherent joint transmissions). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for receiving channel state information reference signals from a set of multiple transmission reception points. The communications manager 1220 may be configured as or otherwise support a means for transmitting a channel state information report based on receiving the channel state information reference signals, the channel state information report indicating a subset of transmission reception points selected from the set of multiple transmission reception points for communications with the UE. The communications manager 1220 may be configured as or otherwise support a means for communicating with the subset of transmission reception points based on transmitting the channel state information report.

By including or configuring the communications manager 1220 in accordance with examples as described herein, the device 1205 may support techniques for reduced processing, reduced power consumption, and more efficient utilization of communication resources. In particular, because the device 1205 may select a subset of TRPs with which to communicate from a set of TRPs, the device 1205 may transmit parameters for communicating with the subset of TRPs in a CSI report, and the device 1205 may avoid transmitting some parameters for other TRPs in the set of TRPs. Thus, the device 1205 may expend less power and processing to generate the CSI report (e.g., resulting in the reduced processing and power consumption), and the device 1205 may use less resources to transmit the CSI report (e.g., resulting in the more efficient utilization of communication resources).

In some examples, the communications manager 1220 may be configured to perform various operations (e.g., receiving, monitoring, transmitting) using or otherwise in cooperation with the transceiver 1215, the one or more antennas 1225, or any combination thereof. For example, the communications manager 1220 may be configured to receive or transmit messages or other signaling as described herein via the transceiver 1215. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of TRP selection for coherent joint transmissions as described herein, or the processor 1240 and the memory 1230 may be otherwise configured to perform or support such operations.

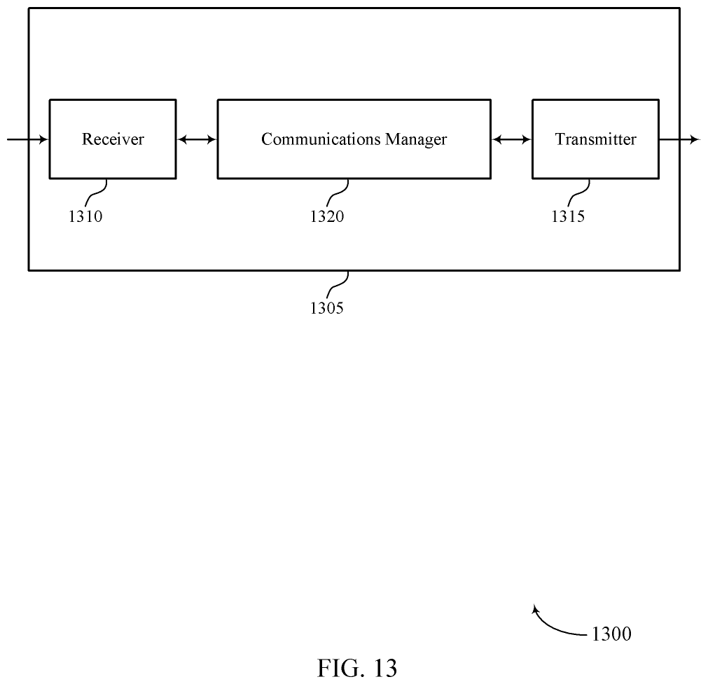

FIG. 13 shows a block diagram 1300 of a device 1305 that supports TRP selection for coherent joint transmissions in accordance with one or more aspects of the present disclosure. The device 1305 may be an example of aspects of a network entity 105 as described herein. In some cases, the device 1305 may be an example of a TRP as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of TRP selection for coherent joint transmissions as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. For example, the communications manager 1320 may be configured as or otherwise support a means for transmitting channel state information reference signals. The communications manager 1320 may be configured as or otherwise support a means for receiving a channel state information report based on transmitting the channel state information reference signals, the channel state information report indicating a subset of transmission reception points selected from a set of multiple transmission reception points for communications with a UE. The communications manager 1320 may be configured as or otherwise support a means for communicating with the UE based on receiving the channel state information report.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing, reduced power consumption, and more efficient utilization of communication resources. Because the device 1305 may support TRP selection for coherent joint transmissions, a UE may avoid communicating with unsuitable TRPs, and the UE may avoid reporting parameters for communications with these TRPs. Thus, the device 1305 may receive and parse less information in a CSI report from the UE (e.g., resulting in the reduced processing and power consumption), and the device 1305 may monitor less resources for the CSI report (e.g., resulting in the more efficient utilization of communication resources).

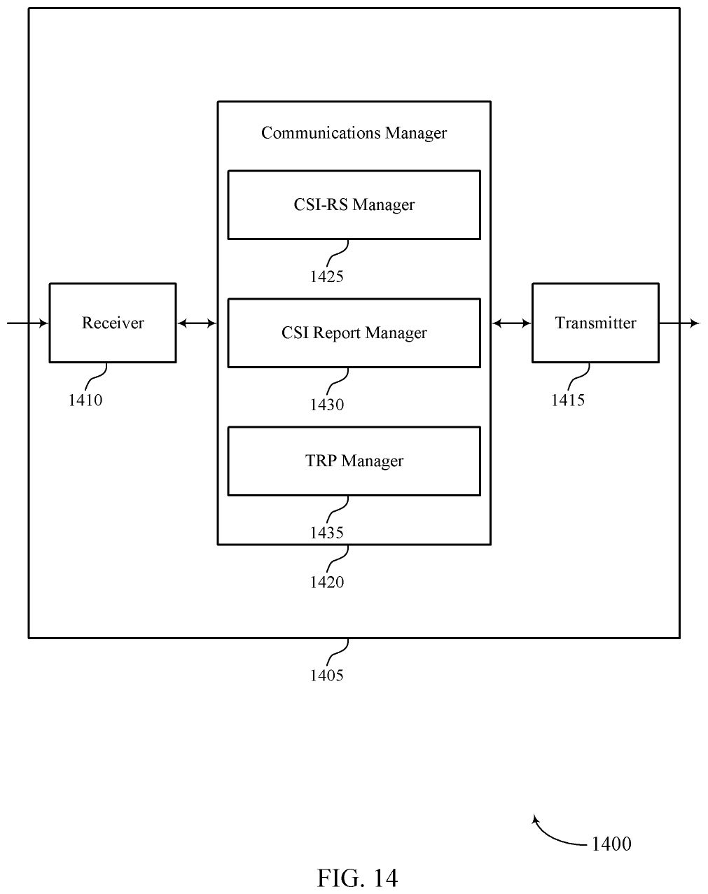

FIG. 14 shows a block diagram 1400 of a device 1405 that supports TRP selection for coherent joint transmissions in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of TRP selection for coherent joint transmissions as described herein. For example, the communications manager 1420 may include a CSI-RS manager 1425, a CSI report manager 1430, an TRP manager 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples as disclosed herein. The CSI-RS manager 1425 may be configured as or otherwise support a means for transmitting channel state information reference signals. The CSI report manager 1430 may be configured as or otherwise support a means for receiving a channel state information report based on transmitting the channel state information reference signals, the channel state information report indicating a subset of transmission reception points selected from a set of multiple transmission reception points for communications with a UE. The TRP manager 1435 may be configured as or otherwise support a means for communicating with the UE based on receiving the channel state information report.

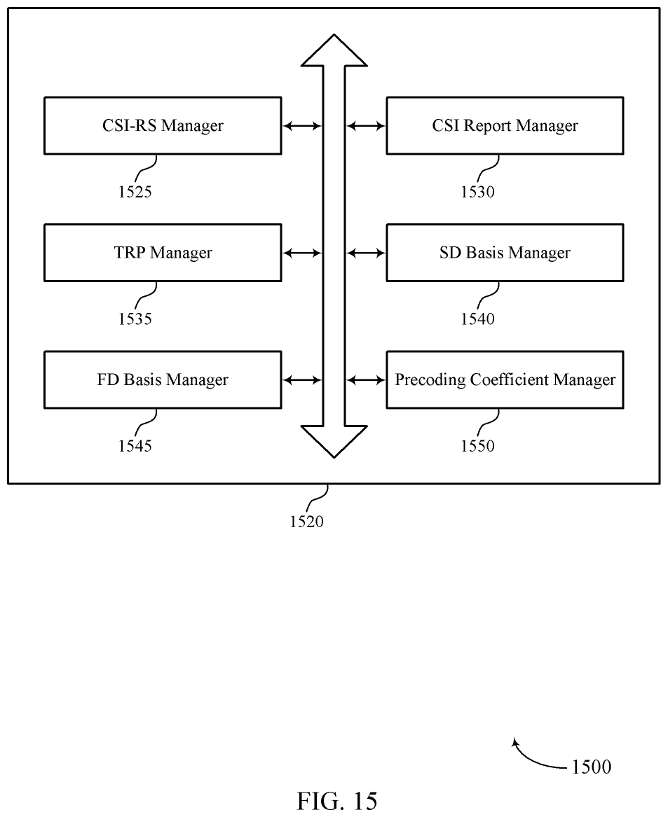

FIG. 15 shows a block diagram 1500 of a communications manager 1520 that supports TRP selection for coherent joint transmissions in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of TRP selection for coherent joint transmissions as described herein. For example, the communications manager 1520 may include a CSI-RS manager 1525, a CSI report manager 1530, an TRP manager 1535, an SD basis manager 1540, an FD basis manager 1545, a precoding coefficient manager 1550, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples as disclosed herein. The CSI-RS manager 1525 may be configured as or otherwise support a means for transmitting channel state information reference signals. The CSI report manager 1530 may be configured as or otherwise support a means for receiving a channel state information report based on transmitting the channel state information reference signals, the channel state information report indicating a subset of transmission reception points selected from a set of multiple transmission reception points for communications with a UE. The TRP manager 1535 may be configured as or otherwise support a means for communicating with the UE based on receiving the channel state information report.

In some examples, the TRP manager 1535 may be configured as or otherwise support a means for receiving, in the channel state information report, a bitmap indicating the subset of transmission reception points for communications with the UE, where a size of the bitmap is proportional to a quantity of the set of multiple transmission reception points.

In some examples, the bitmap indicates a common subset of transmission reception points for communications with the UE on a set of multiple layers.

In some examples, the bitmap indicates a respective subset of transmission reception points for communications with the UE on each layer of a set of multiple layers.

In some examples, the CSI report manager 1530 may be configured as or otherwise support a means for transmitting an indication of a configuration for indicating, in the bitmap, a common subset of transmission reception points for communications with the UE on a first set of multiple layers or a respective subset of transmission reception points for communications with the UE on each layer of a second set of multiple layers.

In some examples, the SD basis manager 1540 may be configured as or otherwise support a means for receiving, in the channel state information report, a common selection of spatial domain bases for each transmission reception point of the subset of transmission reception points to use for communications with the UE on a set of multiple layers.

In some examples, the SD basis manager 1540 may be configured as or otherwise support a means for receiving, in the channel state information report, a respective selection of spatial domain bases for each transmission reception point of the subset of transmission reception points to use for communications with the UE on each layer of a set of multiple layers.

In some examples, a quantity of spatial domain bases indicated in the channel state information report is constant for each transmission reception point of the subset of transmission reception points.

In some examples, a quantity of spatial domain bases indicated in the channel state information report for a transmission reception point of the subset of transmission reception points is based on the transmission reception point.

In some examples, the CSI report manager 1530 may be configured as or otherwise support a means for transmitting an indication of a configuration of a total quantity of spatial domain bases to indicate in the channel state information report. In some examples, the SD basis manager 1540 may be configured as or otherwise support a means for receiving, in the channel state information report, a quantity of spatial domain bases included in the channel state information report for each transmission reception point of the subset of transmission reception points.

In some examples, the FD basis manager 1545 may be configured as or otherwise support a means for receiving, in the channel state information report, a respective number of selected frequency domain bases for each layer of a set of multiple layers based on a quantity of transmission reception points selected for communications with the UE on the layer.

In some examples, the SD basis manager 1540 may be configured as or otherwise support a means for receiving, in the channel state information report for each layer of a set of multiple layers, a common selection of spatial domain bases for each transmission reception point of the subset of transmission reception points to use for communications with the UE.

In some examples, the precoding coefficient manager 1550 may be configured as or otherwise support a means for receiving, in the channel state information report, selected non-zero coefficients for precoding for a first polarization at a first transmission reception point of the subset of transmission reception points, where the first polarization is stronger than a second polarization at the first transmission reception point. In some examples, the precoding coefficient manager 1550 may be configured as or otherwise support a means for receiving, in the channel state information report, first two or more differential amplitudes between the selected non-zero coefficients and coefficients for precoding for a second polarization at each transmission reception point of the subset of transmission reception points. In some examples, the precoding coefficient manager 1550 may be configured as or otherwise support a means for receiving, in the channel state information report, second one or more differential amplitudes between the selected non-zero coefficients and coefficients for precoding at each transmission reception point of the subset of transmission reception points excluding the first transmission reception point.

In some examples, the precoding coefficient manager 1550 may be configured as or otherwise support a means for receiving, in the channel state information report, an indication of whether a first polarization or a second polarization is stronger for each transmission reception point of the subset of transmission reception points.

In some examples, the precoding coefficient manager 1550 may be configured as or otherwise support a means for receiving, in the channel state information report for a first transmission reception point of the subset of transmission reception points, selected non-zero coefficients for precoding for a first polarization at the first transmission reception point. In some examples, the precoding coefficient manager 1550 may be configured as or otherwise support a means for receiving, in the channel state information report for the first transmission reception point, one or more differential amplitudes between the selected non-zero coefficients and coefficients for precoding for a second polarization at the first transmission reception point.

In some examples, to support communicating with the UE, the TRP manager 1535 may be configured as or otherwise support a means for transmitting at least one transmission in a set of multiple transmissions forming a coherent joint transmission to the UE, where phases of the set of multiple transmissions forming the coherent joint transmission are controlled and coordinated by the subset of transmission reception points.

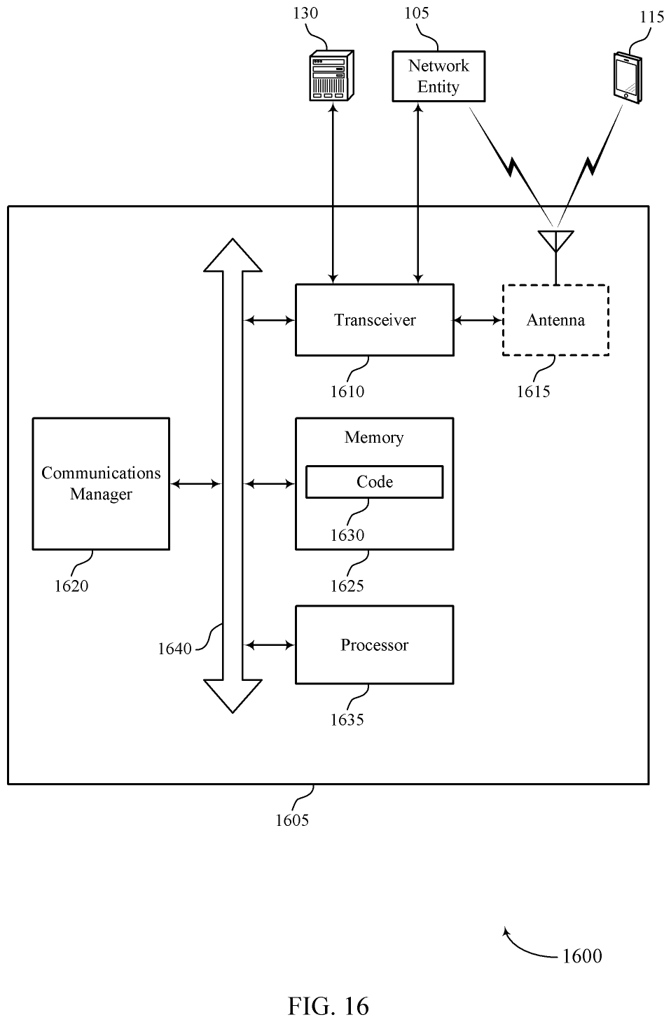

FIG. 16 shows a diagram of a system 1600 including a device 1605 that supports TRP selection for coherent joint transmissions in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting TRP selection for coherent joint transmissions). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity in accordance with examples as disclosed herein. For example, the communications manager 1620 may be configured as or otherwise support a means for transmitting channel state information reference signals. The communications manager 1620 may be configured as or otherwise support a means for receiving a channel state information report based on transmitting the channel state information reference signals, the channel state information report indicating a subset of transmission reception points selected from a set of multiple transmission reception points for communications with a UE. The communications manager 1620 may be configured as or otherwise support a means for communicating with the UE based on receiving the channel state information report.

By including or configuring the communications manager 1620 in accordance with examples as described herein, the device 1605 may support techniques for reduced processing, reduced power consumption, and more efficient utilization of communication resources. Because the device 1605 may support TRP selection for coherent joint transmissions, a UE may avoid communicating with unsuitable TRPs, and the UE may avoid reporting parameters for communications with these TRPs. Thus, the device 1605 may receive and parse less information in a CSI report from the UE (e.g., resulting in the reduced processing and power consumption), and the device 1605 may monitor less resources for the CSI report (e.g., resulting in the more efficient utilization of communication resources).

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. For example, the communications manager 1620 may be configured to receive or transmit messages or other signaling as described herein via the transceiver 1610. Although the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of TRP selection for coherent joint transmissions as described herein, or the processor 1635 and the memory 1625 may be otherwise configured to perform or support such operations.

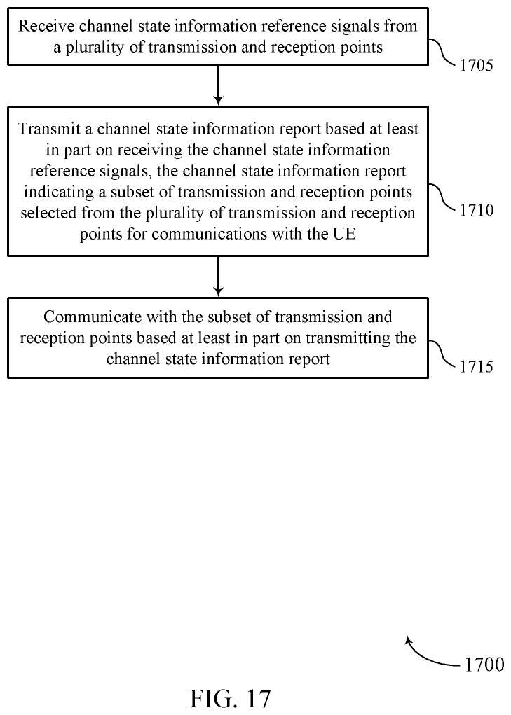

FIG. 17 shows a flowchart illustrating a method 1700 that supports TRP selection for coherent joint transmissions in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving channel state information reference signals from a set of multiple transmission reception points, for example, as shown at 810 with reference to FIG. 8. The operations of 1705 may be performed in accordance with examples as disclosed herein. In some examples, aspects of the operations of 1705 may be performed by a CSI-RS manager 1125 as described with reference to FIG. 11. Additionally, or alternatively, means for performing 1705 may, but not necessarily, include, for example, antenna 1225, transceiver 1215, communications manager 1220, memory 1230 (including code 1235), processor 1240 and/or bus 1245.

At 1710, the method may include transmitting a channel state information report based on receiving the channel state information reference signals, the channel state information report indicating a subset of transmission reception points selected from the set of multiple transmission reception points for communications with the UE, for example, as shown at 820 with reference to FIG. 8. The operations of 1710 may be performed in accordance with examples as disclosed herein. In some examples, aspects of the operations of 1710 may be performed by a CSI report manager 1130 as described with reference to FIG. 11. Additionally, or alternatively, means for performing 1710 may, but not necessarily, include, for example, antenna 1225, transceiver 1215, communications manager 1220, memory 1230 (including code 1235), processor 1240 and/or bus 1245.

At 1715, the method may include communicating with the subset of transmission reception points based on transmitting the channel state information report, for example, as shown at 830 with reference to FIG. 8. The operations of 1715 may be performed in accordance with examples as disclosed herein. In some examples, aspects of the operations of 1715 may be performed by an TRP manager 1135 as described with reference to FIG. 11. Additionally, or alternatively, means for performing 1715 may, but not necessarily, include, for example, antenna 1225, transceiver 1215, communications manager 1220, memory 1230 (including code 1235), processor 1240 and/or bus 1245.

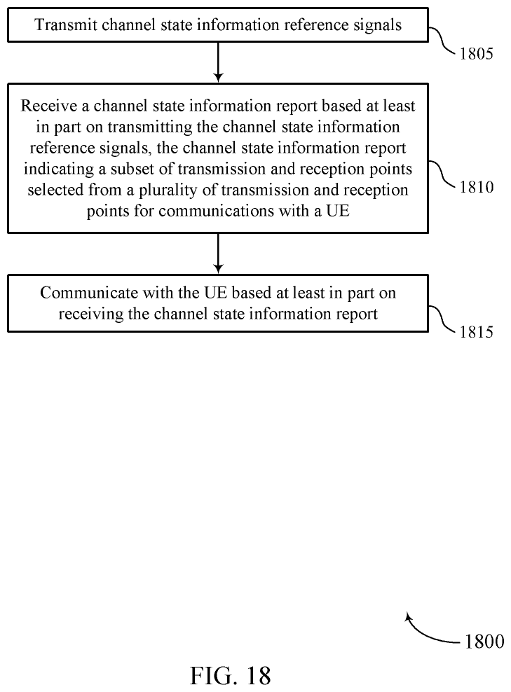

FIG. 18 shows a flowchart illustrating a method 1800 that supports TRP selection for coherent joint transmissions in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include transmitting channel state information reference signals, for example, as shown at 810 with reference to FIG. 8. The operations of 1805 may be performed in accordance with examples as disclosed herein. In some examples, aspects of the operations of 1805 may be performed by a CSI-RS manager 1525 as described with reference to FIG. 15. Additionally, or alternatively, means for performing 1805 may, but not necessarily, include, for example, antenna 1615, transceiver 1610, communications manager 1620, memory 1625 (including code 1630), processor 1635 and/or bus 1640.

At 1810, the method may include receiving a channel state information report based on transmitting the channel state information reference signals, the channel state information report indicating a subset of transmission reception points selected from a set of multiple transmission reception points for communications with a UE, for example, as shown at 820 with reference to FIG. 8. The operations of 1810 may be performed in accordance with examples as disclosed herein. In some examples, aspects of the operations of 1810 may be performed by a CSI report manager 1530 as described with reference to FIG. 15. Additionally, or alternatively, means for performing 1810 may, but not necessarily, include, for example, antenna 1615, transceiver 1610, communications manager 1620, memory 1625 (including code 1630), processor 1635 and/or bus 1640.

At 1815, the method may include communicating with the UE based on receiving the channel state information report, for example, as shown at 830 with reference to FIG. 8. The operations of 1815 may be performed in accordance with examples as disclosed herein. In some examples, aspects of the operations of 1815 may be performed by an TRP manager 1535 as described with reference to FIG. 15. Additionally, or alternatively, means for performing 1815 may, but not necessarily, include, for example, antenna 1615, transceiver 1610, communications manager 1620, memory 1625 (including code 1630), processor 1635 and/or bus 1640.

The following provides an overview of aspects of the present disclosure:
Aspect 1: A method for wireless communication at a UE, comprising: receiving channel state information reference signals from a plurality of transmission reception points: transmitting a channel state information report based at least in part on receiving the channel state information reference signals, the channel state information report indicating a subset of transmission reception points selected from the plurality of transmission reception points for communications with the UE; and communicating with the subset of transmission reception points based at least in part on transmitting the channel state information report.
Aspect 2: The method of aspect 1, further comprising: transmitting, in the channel state information report, a bitmap indicating the subset of transmission reception points for communications with the UE, wherein a size of the bitmap is proportional to a quantity of the plurality of transmission reception points.
Aspect 3: The method of aspect 2, wherein the bitmap indicates a common subset of transmission reception points for communications with the UE on a plurality of layers.
Aspect 4: The method of any of aspects 2 through 3, wherein the bitmap indicates a respective subset of transmission reception points for communications with the UE on each layer of a plurality of layers.
Aspect 5: The method of any of aspects 2 through 4, further comprising: receiving an indication of a configuration for indicating, in the bitmap, a common subset of transmission reception points for communications with the UE on a first plurality of layers or a respective subset of transmission reception points for communications with the UE on each layer of a second plurality of layers.
Aspect 6: The method of any of aspects 1 through 5, further comprising: transmitting, in the channel state information report, a common selection of spatial domain bases for each transmission reception point of the subset of transmission reception points to use for communications with the UE on a plurality of layers.
Aspect 7: The method of any of aspects 1 through 6, further comprising: transmitting, in the channel state information report, a respective selection of spatial domain bases for each transmission reception point of the subset of transmission reception points to use for communications with the UE on each layer of a plurality of layers.
Aspect 8: The method of any of aspects 1 through 7, wherein a quantity of spatial domain bases indicated in the channel state information report is constant for each transmission reception point of the subset of transmission reception points.
Aspect 9: The method of any of aspects 1 through 8, wherein a quantity of spatial domain bases indicated in the channel state information report for a transmission reception point of the subset of transmission reception points is based at least in part on the transmission reception point.
Aspect 10: The method of any of aspects 1 through 9, further comprising: receiving an indication of a configuration of a total quantity of spatial domain bases to indicate in the channel state information report; and transmitting, in the channel state information report, a quantity of spatial domain bases included in the channel state information report for each transmission reception point of the subset of transmission reception points.
Aspect 11: The method of any of aspects 1 through 10, further comprising: transmitting, in the channel state information report, a respective number of selected frequency domain bases for each layer of a plurality of layers based at least in part on a quantity of transmission reception points selected for communications with the UE on the layer.
Aspect 12: The method of any of aspects 1 through 11, further comprising: transmitting, in the channel state information report for each layer of a plurality of layers, a common selection of spatial domain bases for each transmission reception point of the subset of transmission reception points to use for communications with the UE.
Aspect 13: The method of any of aspects 1 through 12, further comprising: transmitting, in the channel state information report, selected non-zero coefficients for precoding for a first polarization at a first transmission reception point of the subset of transmission reception points, wherein the first polarization is stronger than a second polarization at the first transmission reception point: transmitting, in the channel state information report, first two or more differential amplitudes between the selected non-zero coefficients and coefficients for precoding for a second polarization at each transmission reception point of the subset of transmission reception points; and transmitting, in the channel state information report, second one or more differential amplitudes between the selected non-zero coefficients and coefficients for precoding at each transmission reception point of the subset of transmission reception points excluding the first transmission reception point.
Aspect 14: The method of aspect 13, further comprising: transmitting, in the channel state information report, an indication of whether a first polarization or a second polarization is stronger for each transmission reception point of the subset of transmission reception points.
Aspect 15: The method of any of aspects 1 through 14, further comprising: transmitting, in the channel state information report for a first transmission reception point of the subset of transmission reception points, selected non-zero coefficients for precoding for a first polarization at the first transmission reception point; and transmitting, in the channel state information report for the first transmission reception point, one or more differential amplitudes between the selected non-zero coefficients and coefficients for precoding for a second polarization at the first transmission reception point.
Aspect 16: The method of any of aspects 1 through 15, wherein communicating with the subset of transmission reception points comprises: receiving a coherent joint transmission from the subset of transmission reception points, wherein phases of a plurality of transmissions forming the coherent joint transmission are controlled and coordinated by the subset of transmission reception points.
Aspect 17: A method for wireless communication at a network entity, comprising: transmitting channel state information reference signals: receiving a channel state information report based at least in part on transmitting the channel state information reference signals, the channel state information report indicating a subset of transmission reception points selected from a plurality of transmission reception points for communications with a UE; and communicating with the UE based at least in part on receiving the channel state information report.
Aspect 18: The method of aspect 17, further comprising: receiving, in the channel state information report, a bitmap indicating the subset of transmission reception points for communications with the UE, wherein a size of the bitmap is proportional to a quantity of the plurality of transmission reception points.
Aspect 19: The method of aspect 18, wherein the bitmap indicates a common subset of transmission reception points for communications with the UE on a plurality of layers.
Aspect 20: The method of any of aspects 18 through 19, wherein the bitmap indicates a respective subset of transmission reception points for communications with the UE on each layer of a plurality of layers.
Aspect 21: The method of any of aspects 18 through 20, further comprising: transmitting an indication of a configuration for indicating, in the bitmap, a common subset of transmission reception points for communications with the UE on a first plurality of layers or a respective subset of transmission reception points for communications with the UE on each layer of a second plurality of layers.
Aspect 22: The method of any of aspects 17 through 21, further comprising: receiving, in the channel state information report, a common selection of spatial domain bases for each transmission reception point of the subset of transmission reception points to use for communications with the UE on a plurality of layers.
Aspect 23: The method of any of aspects 17 through 22, further comprising: receiving, in the channel state information report, a respective selection of spatial domain bases for each transmission reception point of the subset of transmission reception points to use for communications with the UE on each layer of a plurality of layers.
Aspect 24: The method of any of aspects 17 through 23, wherein a quantity of spatial domain bases indicated in the channel state information report is constant for each transmission reception point of the subset of transmission reception points.
Aspect 25: The method of any of aspects 17 through 24, wherein a quantity of spatial domain bases indicated in the channel state information report for a transmission reception point of the subset of transmission reception points is based at least in part on the transmission reception point.
Aspect 26: The method of any of aspects 17 through 25, further comprising: transmitting an indication of a configuration of a total quantity of spatial domain bases to indicate in the channel state information report; and receiving, in the channel state information report, a quantity of spatial domain bases included in the channel state information report for each transmission reception point of the subset of transmission reception points.
Aspect 27: The method of any of aspects 17 through 26, further comprising: receiving, in the channel state information report, a respective number of selected frequency domain bases for each layer of a plurality of layers based at least in part on a quantity of transmission reception points selected for communications with the UE on the layer.
Aspect 28: The method of any of aspects 17 through 27, further comprising: receiving, in the channel state information report for each layer of a plurality of layers, a common selection of spatial domain bases for each transmission reception point of the subset of transmission reception points to use for communications with the UE.
Aspect 29: The method of any of aspects 17 through 28, further comprising: receiving, in the channel state information report, selected non-zero coefficients for precoding for a first polarization at a first transmission reception point of the subset of transmission reception points, wherein the first polarization is stronger than a second polarization at the first transmission reception point: receiving, in the channel state information report, first two or more differential amplitudes between the selected non-zero coefficients and coefficients for precoding for a second polarization at each transmission reception point of the subset of transmission reception points; and receiving, in the channel state information report, second one or more differential amplitudes between the selected non-zero coefficients and coefficients for precoding at each transmission reception point of the subset of transmission reception points excluding the first transmission reception point.
Aspect 30: The method of aspect 29, further comprising: receiving, in the channel state information report, an indication of whether a first polarization or a second polarization is stronger for each transmission reception point of the subset of transmission reception points.
Aspect 31: The method of any of aspects 17 through 30, further comprising: receiving, in the channel state information report for a first transmission reception point of the subset of transmission reception points, selected non-zero coefficients for precoding for a first polarization at the first transmission reception point; and receiving, in the channel state information report for the first transmission reception point, one or more differential amplitudes between the selected non-zero coefficients and coefficients for precoding for a second polarization at the first transmission reception point.
Aspect 32: The method of any of aspects 17 through 31, wherein communicating with the UE comprises: transmitting at least one transmission in a plurality of transmissions forming a coherent joint transmission to the UE, wherein phases of the plurality of transmissions forming the coherent joint transmission are controlled and coordinated by the subset of transmission reception points.
Aspect 33: An apparatus for wireless communication at a UE, comprising a memory, a transceiver, and at least one processor coupled with the memory and the transceiver, the at least one processor configured to perform a method of any of aspects 1 through 16.
Aspect 34: An apparatus for wireless communication at a UE, comprising at least one means for performing a method of any of aspects 1 through 16.
Aspect 35: A non-transitory computer-readable medium storing code for wireless communication at a UE, the code comprising instructions executable by a processor to perform a method of any of aspects 1 through 16.
Aspect 36: An apparatus for wireless communication at a network entity, comprising a memory, a transceiver, and at least one processor coupled with the memory and the transceiver, the at least one processor configured to perform a method of any of aspects 17 through 32.
Aspect 37: An apparatus for wireless communication at a network entity, comprising at least one means for performing a method of any of aspects 17 through 32.
Aspect 38: A non-transitory computer-readable medium storing code for wireless communication at a network entity, the code comprising instructions executable by a processor to perform a method of any of aspects 17 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
memory;
a transceiver; and
at least one processor of a user equipment (UE), the at least one processor coupled with the memory and the transceiver, and the at least one processor configured to:
receive, via the transceiver, channel state information reference signals from a plurality of transmission reception points;
transmit, via the transceiver, a channel state information report based at least in part on receiving the channel state information reference signals, the channel state information report indicating a subset of transmission reception points selected from the plurality of transmission reception points for communications with the UE; and
communicate with the subset of transmission reception points based at least in part on transmitting the channel state information report.

2. The apparatus of claim 1, wherein the at least one processor is further configured to:
transmit, in the channel state information report, a bitmap indicating the subset of transmission reception points for communications with the UE, wherein a size of the bitmap is proportional to a quantity of the plurality of transmission reception points.

3. The apparatus of claim 2, wherein the bitmap indicates a common subset of transmission reception points for communications with the UE on a plurality of layers.

4. The apparatus of claim 2, wherein the bitmap indicates a respective subset of transmission reception points for communications with the UE on each layer of a plurality of layers.

5. The apparatus of claim 2, wherein the at least one processor is further configured to:
receive an indication of a configuration for indicating, in the bitmap, a common subset of transmission reception points for communications with the UE on a first plurality of layers or a respective subset of transmission reception points for communications with the UE on each layer of a second plurality of layers.

6. The apparatus of claim 1, wherein the at least one processor is further configured to:
transmit, in the channel state information report, a common selection of spatial domain bases for each transmission reception point of the subset of transmission reception points to use for communications with the UE on a plurality of layers.

7. The apparatus of claim 1, wherein the at least one processor is further configured to:
transmit, in the channel state information report, a respective selection of spatial domain bases for each transmission reception point of the subset of transmission reception points to use for communications with the UE on each layer of a plurality of layers.

8. The apparatus of claim 1, wherein a quantity of spatial domain bases indicated in the channel state information report is constant for each transmission reception point of the subset of transmission reception points.

9. The apparatus of claim 1, wherein a quantity of spatial domain bases indicated in the channel state information report for a transmission reception point of the subset of transmission reception points is based at least in part on the transmission reception point.

10. The apparatus of claim 1, wherein the at least one processor is further configured to:
receive an indication of a configuration of a total quantity of spatial domain bases to indicate in the channel state information report; and
transmit, in the channel state information report, a quantity of spatial domain bases included in the channel state information report for each transmission reception point of the subset of transmission reception points.

11. The apparatus of claim 1, wherein the at least one processor is further configured to:
transmit, in the channel state information report, a respective number of selected frequency domain bases for each layer of a plurality of layers based at least in part on a quantity of transmission reception points selected for communications with the UE on the layer.

12. The apparatus of claim 1, wherein the at least one processor is further configured to:
transmit, in the channel state information report for each layer of a plurality of layers, a common selection of spatial domain bases for each transmission reception point of the subset of transmission reception points to use for communications with the UE.

13. The apparatus of claim 1, wherein the at least one processor is further configured to:
transmit, in the channel state information report, selected non-zero coefficients for precoding for a first polarization at a first transmission reception point of the subset of transmission reception points, wherein the first polarization is stronger than a second polarization at the first transmission reception point;
transmit, in the channel state information report, first two or more differential amplitudes between the selected non-zero coefficients and coefficients for precoding for a second polarization at each transmission reception point of the subset of transmission reception points; and
transmit, in the channel state information report, second one or more differential amplitudes between the selected non-zero coefficients and coefficients for precoding at each transmission reception point of the subset of transmission reception points excluding the first transmission reception point.

14. The apparatus of claim 13, wherein the at least one processor is further configured to:
transmit, in the channel state information report, an indication of whether the first polarization or the second polarization is stronger for each transmission reception point of the subset of transmission reception points.

15. The apparatus of claim 1, wherein the at least one processor is further configured to:
transmit, in the channel state information report for a first transmission reception point of the subset of transmission reception points, selected non-zero coefficients for precoding for a first polarization at the first transmission reception point; and
transmit, in the channel state information report for the first transmission reception point, one or more differential amplitudes between the selected non-zero coefficients and coefficients for precoding for a second polarization at the first transmission reception point.

16. The apparatus of claim 1, wherein the at least one processor is further configured to:
receive a coherent joint transmission from the subset of transmission reception points, wherein phases of a plurality of transmissions forming the coherent joint transmission are controlled and coordinated by the subset of transmission reception points.

17. An apparatus for wireless communication at a network entity, comprising:
memory;
a transceiver; and
at least one processor of the network entity, the at least one processor coupled with the memory and the transceiver, and the at least one processor configured to:
transmit channel state information reference signals;
receive a channel state information report based at least in part on transmitting the channel state information reference signals, the channel state information report indicating a subset of transmission reception points selected from a plurality of transmission reception points for communications with a user equipment (UE); and
communicate with the UE based at least in part on receiving the channel state information report.

18. The apparatus of claim 17, wherein the at least one processor is further configured to:
receive, in the channel state information report, a bitmap indicating the subset of transmission reception points for communications with the UE, wherein a size of the bitmap is proportional to a quantity of the plurality of transmission reception points.

19. The apparatus of claim 18, wherein the bitmap indicates a common subset of transmission reception points for communications with the UE on a plurality of layers.

20. The apparatus of claim 18, wherein the bitmap indicates a respective subset of transmission reception points for communications with the UE on each layer of a plurality of layers.

21. The apparatus of claim 18, wherein the at least one processor is further configured to:
transmit an indication of a configuration for indicating, in the bitmap, a common subset of transmission reception points for communications with the UE on a first plurality of layers or a respective subset of transmission reception points for communications with the UE on each layer of a second plurality of layers.

22. The apparatus of claim 17, wherein the at least one processor is further configured to:
receive, in the channel state information report, a common selection of spatial domain bases for each transmission reception point of the subset of transmission reception points to use for communications with the UE on a plurality of layers.

23. The apparatus of claim 17, wherein the at least one processor is further configured to:
receive, in the channel state information report, a respective selection of spatial domain bases for each transmission reception point of the subset of transmission reception points to use for communications with the UE on each layer of a plurality of layers.

24. The apparatus of claim 17, wherein a quantity of spatial domain bases indicated in the channel state information report is constant for each transmission reception point of the subset of transmission reception points.

25. The apparatus of claim 17, wherein a quantity of spatial domain bases indicated in the channel state information report for a transmission reception point of the subset of transmission reception points is based at least in part on the transmission reception point.

26. The apparatus of claim 17, wherein the at least one processor is further configured to:
transmit an indication of a configuration of a total quantity of spatial domain bases to indicate in the channel state information report; and
receive, in the channel state information report, a quantity of spatial domain bases included in the channel state information report for each transmission reception point of the subset of transmission reception points.

27. The apparatus of claim 17, wherein the at least one processor is further configured to:
receive, in the channel state information report, a respective number of selected frequency domain bases for each layer of a plurality of layers based at least in part on a quantity of transmission reception points selected for communications with the UE on the layer.

28. The apparatus of claim 17, wherein the at least one processor is further configured to:
receive, in the channel state information report for each layer of a plurality of layers, a common selection of spatial domain bases for each transmission reception point of the subset of transmission reception points to use for communications with the UE.

29. A method for wireless communication at a user equipment (UE), comprising:
receiving channel state information reference signals from a plurality of transmission reception points;
transmitting a channel state information report based at least in part on receiving the channel state information reference signals, the channel state information report indicating a subset of transmission reception points selected from the plurality of transmission reception points for communications with the UE; and
communicating with the subset of transmission reception points based at least in part on transmitting the channel state information report.

30. A method for wireless communication at a network entity, comprising:
transmitting channel state information reference signals;
receiving a channel state information report based at least in part on transmitting the channel state information reference signals, the channel state information report indicating a subset of transmission reception points selected from a plurality of transmission reception points for communications with a user equipment (UE); and
communicating with the UE based at least in part on receiving the channel state information report.
